(19) United States
(12) Patent Application Publication
(10) Pub. No.: US 2024/0007980 A1
(43) Pub. Date: Jan. 4, 2024

(54) METHOD AND APPARATUS FOR SYNCHRONISING THE APPARATUSES OF A WIRELESS NETWORK

(71) Applicant: CANON KABUSHIKI KAISHA, Tokyo (JP)

(72) Inventors: Romain GUIGNARD, RENNES (FR); Yacine EL KOLLI, RENNES (FR)

(21) Appl. No.: 18/252,697

(22) PCT Filed: Nov. 19, 2021
(86) PCT No.: PCT/EP2021/082327

§ 371 Date: May 11, 2023

(30) Foreign Application Priority Data
Nov. 19, 2020 (GB) 2018235.8
Apr. 30, 2021 (GB) 2106276.5

(51) Int. Cl. H04W 56/00; H04W 72/02; H04W 72/0446

(52) U.S. Cl. CPC H04W 56/0045; H04W 56/0015; H04W 72/02; H04W 72/0446

(57) ABSTRACT

The present invention concerns a method of updating a time counter of a user equipment in a wireless network comprising a base station and a plurality of user equipment, the method comprising, at the user equipment:
receiving a reference time and an indication for determining a reference time point associated with the reference time;
scheduling a determining of a propagation delay relatively to the reference time point;
determining a propagation delay with the base station according to the scheduling; and
updating the time counter using the reference time and the determined propagation delay.

### FIELD OF THE INVENTION

The present disclosure concerns a method and a device for synchronising the apparatuses of a wireless network, such as radio communication network.

### BACKGROUND OF INVENTION

The uses of the Internet of Things, IoT, are multiplying, each use being accompanied by particular constraints.

One use of IoT is in the industry, for example in production plants using critical machines and a plurality of sensors and actuators. IoT makes it possible, for example, to precisely track a production line by implementing the following functions (non-exhaustive list): predictive maintenance (avoiding production interruptions by identifying early warning signs of failures to proactively schedule maintenance intervention), intelligent diagnostics (by recording operational data and repair history through sensors), production line optimisation, production machines optimisation, etc.

With the development of the 5G technology, a new generation of IoT is developing. However, it is still necessary to ensure that a 5G network is compatible with time sensitive applications implemented by IoT elements.

To do that, an accurate time synchronisation is required within the 5G network.

A conventional reference system frame mechanism is proposed. A base station provides a user equipment with information for time synchronisation, such as a reference time linked to the occurrence of a reference system frame provided by the base station. The user equipment then sets a local time counter to the reference time, upon receiving a reference frame signalling a reference time point within the reference system frame.

The synchronisation based on the reference system frame mechanism may be improved by compensating the propagation delay, i.e. the time taken by the reference frame to reach the user equipment.

To do that, several solutions exist including those making use of the Precision Time Protocol (IEEE1588) adapted to 5G system for measuring the propagation delay between the user equipment and the base station during a position triangulation estimate.

The Precision Time Protocol mechanism consists in exchanging an uplink frame and a downlink frame between the user equipment and the base station. Then, both the user equipment and the base station store the transmission and the receiving times of the exchanged frames in order to estimate the round-trip time (RTT). The propagation delay is then calculated by the user equipment based on the estimated RTT (more precisely based on the half of it), and used to update its local time counter.

Another known solution for measuring the propagation delay is referred to as Timing Advance (TA) mechanism, as described in TS 38.211 clause 4.3. This mechanism aims at controlling the timing of the user equipment's uplink frames. It provides timing values correction within a Timing Advance (TA) command per user equipment which considers the propagation delay estimated for the user equipment.

To do that, the base station schedules the transmission time of an uplink frame by the user equipment and regularly monitors the propagation delay of this scheduled uplink frame, as it knows its transmission time and can detect its reception time. The base station then calculates the propagation delay before sharing it (or a correction thereof) with the user equipment using a subsequent message that may be a subsequent TA command.

However, these known mechanisms have limitations. Indeed, network conditions and the position of the user equipment may significantly change during the time synchronisation process. In this case, the estimated propagation delay does not reflect properly the real propagation delay of the reference frame based on which the local time counter is initially set. Consequently, a substantial desynchronisation of the time counter may persist over time.

Thus, there is a need for a more accurate synchronisation mechanism.

### SUMMARY OF THE INVENTION

The present invention has been devised to address one or more of the foregoing concerns. It concerns a mechanism for updating a time counter of a user equipment UE, where the reference time point of the reference system frame is thus used to schedule or trigger the measurement of the propagation delay (or the measurement of the RTT) as closely as possible to the reference time point, hence as closely as possible to the reference frame.

In other words, it defines a dedicated method to measure the propagation delay allowing to trigger the measurement close to the reference SFN.

There is provided a method of updating a time counter of a user equipment in a wireless network comprising a base station and a plurality of user equipment, the method comprising, at the user equipment:
receiving a reference time and an indication for determining a reference time point associated with the reference time;
scheduling a determining of a propagation delay relatively to the reference time point;
determining a propagation delay with the base station according to the scheduling; and
updating the time counter using the reference time and the determined propagation delay.

According to some embodiments, the reference time point may be the end of a reference system frame and wherein the indication may comprise the sequence number of the reference system frame.

According to some embodiments, the reference time point may be the start of a reference system frame and wherein the indication may comprise the sequence number of a system frame preceding the reference system frame.

According to a first aspect of the invention there is provided a method of updating a time counter of a user equipment in a wireless network comprising at least one base station and a plurality of user equipment, the method comprising, at the user equipment:
receiving a reference frame to signal a reference time point associated with a reference time in a reference system frame;
determining a propagation delay with the base station;
updating the time counter using the reference time and the determined propagation delay;
wherein the determining of the propagation delay is scheduled relatively to the reference time point of the reference system frame.

In this way, as the propagation delay estimation is temporally closer to the reference time point and reference frame, the estimated propagation delay is as close as possible to the actual propagation delay between the UE and the gNB when the reference time point occurs.

Consequently, the updating of the time counter with the determined propagation delay is more accurate, and the compensation of the error relative to the propagation delay of the reference frame is then improved.

Optional features of the invention are defined in the appended claims. Some of these features are explained here below with reference to a method, while they can be transposed into system features dedicated to a user equipment of a wireless network according to the invention.

According to some embodiments, the scheduling of the determining of the propagation delay may further comprise:
scheduling the transmission of a first measurement frame relatively to the reference time point.

According to some embodiments, the first measurement frame may be scheduled to be transmitted during the reference system frame, preferably during a reference system subframe comprising the reference time point or a reference system subframe preceding the reference subframe comprising the reference time point.

According to some embodiments, the first measurement frame may be scheduled to be transmitted during a predetermined system frame preceding the reference system frame, preferably immediately preceding the reference system frame.

According to some embodiments, the scheduling of the determining of the propagation delay may further comprise:
determining a time to initiate the determining of the propagation delay, based on a system frame number of a current system frame, a current value of the time counter and a system frame number of the reference system frame.

According to some embodiments, the scheduling of the determining of the propagation delay may further comprise:
setting a decrementing timer to the determined initiation time; and initiating the determining of the propagation delay when the decrementing timer expires.

According to some embodiments, the scheduling of the determining of a propagation delay may include retrieving, from a message received from the base station, a transmission time setting the time for transmission of a first measurement frame,
and wherein the determining of the propagation delay may include receiving, from the base station, a Timing Advance command comprising information relating to a propagation delay estimated by the base station.

According to some embodiments, the determining of a propagation delay with the base station may comprise:
transmitting a first measurement frame to the base station;
storing a time of transmission of the first measurement frame;
receiving a second measurement frame from the base station;
storing a time of receiving of the second measurement frame.

According to some embodiments, the second measurement frame may be transmitted during the reference system frame, preferably the second measurement frame may be the reference frame signalling the reference time point.

According to some embodiments, the second measurement frame may be transmitted during a system frame immediately following the reference system frame.

According to some embodiments, the method may further comprise, at the user equipment:
receiving, from the base station, at least one parameter for determining the propagation delay with the base station.

According to some embodiments, the at least one parameter may comprise at least one of a time of arrival of the first measurement frame at the base station, a time of transmitting of the second measurement frame by the base station and a difference between the time of arrival of the first measurement frame and the time of transmitting of the second measurement frame.

According to some embodiments, the at least one parameter may be received within the second measurement frame.

According to some embodiments, the at least one parameter may be received within a message additional to the second measurement frame, within a system frame immediately following the reference system frame.

According to some embodiments, a time of arrival of the first measurement frame at the base station may be received within the second measurement frame, and a time of transmitting of the second measurement frame by the base station may be received in an additional message following the second measurement frame.

According to some embodiments, the propagation delay may be determined using the stored time of transmission of the first frame, the stored time of receiving of the second frame and the at least one parameter for determining the propagation delay.

According to another aspect of the invention there is provided a method of updating a time counter of a user equipment in a wireless network comprising at least one base station and a plurality of user equipment, the method comprising, at the base station:
transmitting a reference frame to signal a reference time point associated with a reference time in a reference system frame, in order to set the time counter of the user equipment;
transmitting a measurement frame to the user equipment;
wherein the transmission of the measurement frame is scheduled relatively to the reference time point of the reference system frame.

According to another aspect of the invention there is provided a method of updating a time counter of a user equipment in a wireless network comprising at least one base station and a plurality of user equipment, the method comprising at the base station:
transmitting a reference frame to signal a reference time point associated with a reference time in a reference system frame, in order to set the time counter of the user equipment;
wherein the method further comprises:
selecting at least one resource within a system frame relatively to the reference time point of the reference system frame;
selecting at least one resource allocation scheme for the selected resource, a resource allocation scheme defining an allocation of each symbols of the selected resource to downlink transmission or uplink transmission or both;
performing a propagation delay measurement by exchanging at least one measurement frame using the selected resource.

Such a method ensures that the determination of a propagation delay between the UE and the gNB is performed as close as possible to the reference time point, in order to improve the accuracy of the updating of the time counter of the UE. Indeed, based on the selected resource allocation scheme provided by the gNB, the UE (and optionally the gNB) may schedule the transmission of the first measurement frame of either PTP method or TA mechanism (and optionally the second measurement frame, in case of PTP method) to fall in resources having the appropriate uplink (and optionally downlink) property.

Optional features of the invention are defined in the appended claims. Some of these features are explained here below with reference to a method, while they can be transposed into system features dedicated to a base station of a wireless network according to the invention.

According to some embodiments, the selected resource may be a time slot of a system frame and the selecting steps may further comprise:
selecting at least one time slot in a system frame relatively to the reference time point of the reference system frame;
selecting, for each selected time slot, a slot allocation scheme from amongst predefined slot allocation schemes, a slot allocation scheme defining an allocation of each symbol composing a time slot to downlink transmission or uplink transmission or both.

According to some embodiments, a selected resource may be comprised in the reference system frame or in a system frame adjacent to the reference system frame.

According to some embodiments, a selected resource may be immediately adjacent to the reference time point.

According to some embodiments, a selected resource allocation scheme for a first selected resource may include at least one uplink symbol and a first measurement frame may be received from the user equipment over the at least one uplink symbol.

According to some embodiments, the selected resource allocation scheme for the first selected resource further may include at least one downlink symbol and a second measurement frame may be transmitted to the user equipment over the at least one downlink symbol.

According to some embodiments, the uplink symbol and the downlink symbol may be time-division duplexed.

According to some embodiments, the uplink symbol and the downlink symbol may be frequency-division duplexed.

According to some embodiments, a selected resource allocation scheme for a second selected resource may include at least one downlink symbol and at least one further measurement frame may be transmitted to the user equipment over the at least one downlink symbol.

According to some embodiments, the at least one further measurement frame may include a second measurement frame.

According to some embodiments, the at least one further measurement frame may include a follow-up measurement frame providing the user equipment with time information of one or more exchanged measurement frames.

According to some embodiments, the first resource may be a last slot of the reference system frame.

According to some embodiments, the second resource may be a starting slot of the system frame immediately following the reference system frame.

According to some embodiments, all slots of a subframe in a system frame may be selected with a resource allocation scheme providing only uplink symbols made of a plurality of subcarriers, and a first measurement frame may be received from the user equipment over slots of this subframe.

According to some embodiments, all slots of another subframe in a system frame may be selected with a resource allocation scheme providing only downlink symbols made of a plurality of subcarriers, and a second measurement frame may be transmitted to the user equipment over slots of this other subframe.

According to some embodiments, the subframe and the other subframe may be consecutive subframes in the same system frame.

According to some embodiments, the subframe and the other subframe may be the two last subframes of the same system frame According to some embodiments, an end of the same system frame may correspond to the reference time point.

According to another aspect of the invention there is provided a method of updating a time counter of a user equipment in a wireless network comprising at least one base station and a plurality of user equipment, the method comprising at the base station:
transmitting a reference frame to signal a reference time point associated with a reference time in a reference system frame, in order to set the time counter of the user equipment;
performing a propagation delay measurement by exchanging at least one measurement frame using at least one resource of a system frame,
wherein the reference time point is determined based on a resource allocation scheme of the at least one resource.

Correspondingly, there is provided a device in a wireless network comprising at least one base station and a plurality of user equipment comprising a processor configured to perform the steps of method as described hereinbefore.

The device has the same advantages as the method defined above.

According to another aspect of the invention there is provided a computer-readable storage medium storing instructions of a computer program for implementing a method as described hereinbefore when loaded into and executed by a programmable apparatus.

According to another aspect of the invention there is provided a computer program which upon execution causes the method as described hereinbefore to be performed.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates an 5G network interconnecting connected objects;

FIG. 2 is a diagram illustrating an example of architecture of a base station of the illustrated 5G network of FIG. 1;

FIG. 3 is a diagram illustrating an example of architecture of a user equipment of the illustrated 5G network of FIG. 1;

FIG. 4 illustrates a system frame of a 5G network;

FIG. 5 illustrates mechanisms of the prior art for updating the timer of a user equipment;

FIGS. 6a and 6b illustrate mechanisms of the prior art for estimating the propagation delay between the base station and the user equipment;

FIGS. 7a and 7b illustrates general principles of the first aspect of the invention;

FIGS. 8, 8a and 8b illustrate methods implemented at the base station, wherein FIGS. 8a and 8b are respectively according to the first and a second embodiments of the first aspect of the invention;

FIGS. 9, 9a and 9b illustrate methods implemented at the user equipment, wherein FIGS. 9a and 9b are respectively according to a first and a second embodiments of the first aspect of invention:

FIG. 10 and FIG. 11 illustrate alternatives of the first embodiment according to the first aspect of the invention;

FIG. 12 illustrates a second embodiment according to the first aspect of the invention;

FIG. 13 illustrates the resource allocation in time division duplex (TDD) according to the second aspect of the invention;

FIG. 14 illustrates the resource allocation in frequency division duplex (FDD) according to the second aspect of the invention;

FIG. 15 illustrates the resource allocation of reference signals consistent with the propagation delay measurement according to the first aspect of the invention; and

FIGS. 16, 17 and 18 illustrate four embodiments of the resource allocation method performed at the gNB.

### DETAILED DESCRIPTION OF THE INVENTION

The names of the lists and elements (such as data elements) provided in the following description are only illustrative. Embodiments are not limited thereto and other names could be used.

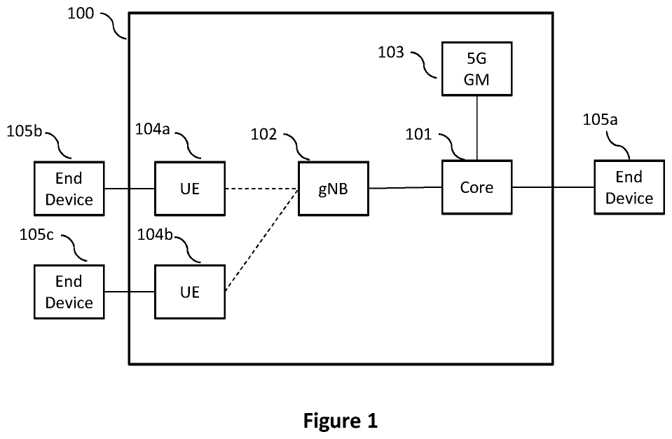

The embodiments of the present invention are intended to be implemented in 5G networks used for interconnecting connected objects or terminals as the one illustrated in FIG. 1.

The 5G network 100 comprises a plurality of user equipment (UE) 104a, 104b also referred to as mobile stations, wirelessly connected (indicated by the dotted lines) to at least one base station 102 (gNB or gNodeB). The gNB 102 is connected to a core network 101, for instance by wires (e.g. using fiber-optic) or wirelessly.

In this 5G network, a common time reference is provided by a Grand Master clock (5G GM) 103, as defined in TS 23.501 clause 5.27.

The 5G GM clock may be connected to the core network 101, as illustrated in FIG. 1, but may also be directly connected to the gNB or to one of the UE. Thus, the device connected to the 5G GM clock shares with other devices of the network, the common time reference provided by the 5G GM clock.

According to some embodiments, the common time reference provided by the 5G GM clock may be the universal time reference or based on it. For example, the universal time reference may be obtained by the gNB directly from a satellite system.

The 5G network 100, as explained above, may be used in order to connect end devices 105a, 105b and 105c, e.g. the connected devices of an IoT network. The end devices may be for example devices for industrial appliances, such as sensors and actuators. As shown in FIG. 1, the end devices 105a, 105b and 105c are connected to the UEs 104a, 104b or the network core 101 of the 5G network 100. According to some embodiments, the end devices 105a, 105b and 105c are wired to the UEs 104a, 104b or the network core 101.

According to some embodiments, one end device and one UE may be integrated within a single device.

Thus, the end devices 105a, 105b and 105c share data using the 5G network.

When implementing time sensitive applications in the IoT network, an accurate time synchronisation between the UEs is mandatory, in particular within the 5G network.

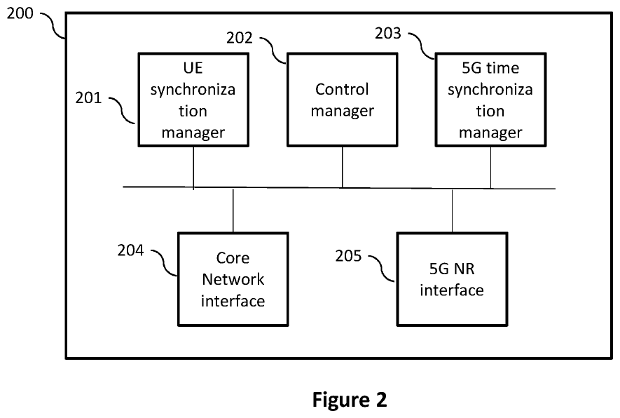

An exemplary and simplified internal architecture of the gNB 102 is illustrated in FIG. 2 by means of a diagram.

The gNB 200 comprises 5G NR interface 205 allowing it to communicate with the UEs 104a, 104b of the 5G network 100. The gNB may also comprise several different types of radio interfaces, such as LTE (4G) or other types of radio interfaces.

In order to communicate with the core network 101, the gNB also comprises a core network interface 204, as defined in TS 23.501 clause 4.2.

The synchronisation of the gNB with the 5G GM clock is handled by a 5G time synchronisation manager 203.

According to some embodiments, the 5G time synchronisation manager 203 implements a time counter incremented by a local clock oscillator. The 5G time synchronisation manager 203 continuously evaluates the time difference between the time counter and the 5G GM clock. The evaluation may be done using the IEEE 1588 Precise Time Synchronisation Protocol implemented through the exchange of time synchronisation packets with the 5G GM clock through the Core Network Interface 204.

The evaluated difference thus enables the 5G time synchronisation manager 203 to determine a value to adjust its time counter.

According to some embodiments, 5G time synchronisation manager 203 continuously evaluates the clock difference between the time counter and the reference time received from a satellite system such as the GPS.

Thus, the 5G time synchronisation manager 203 provides a precise current time to the UE synchronisation manager 201 based on its local time counter.

The UE synchronisation manager 201 is configured to handle the synchronisation between the base station and the UEs 104a, 104b of the network 100 with a view of having the time counters of all these devices be synchronised as precisely as possible.

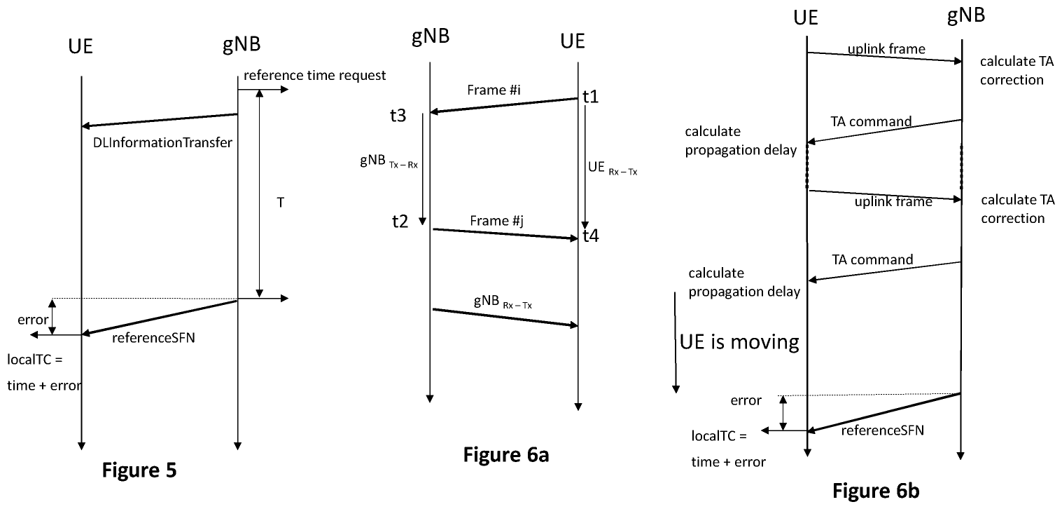

To that end, the UE synchronisation manager 201 may implement several mechanisms, as the ones described hereinafter in relation with FIG. 5. The UE synchronisation manager 201 is also configured to evaluate and record propagation delays between the gNB and each UE 104a, 104b, for synchronisation purposes.

The gNB further comprises a control manager 202 in which the gNB control protocols are implemented. The control protocols comprise at least the following protocols: RLC (Radio Link Control TS 38.322), PDCP (Packet Duplication Control Protocol TS 38.323), RRC (Radio Resources Control TS 38.331) and NAS (Network Access Stratum TS 24.501). The control manager 202 thus handles the generation of the protocol packets exchanged with the core network 101 and the UEs through respectively the Core network interface 204 and the 5G NR interface 205.

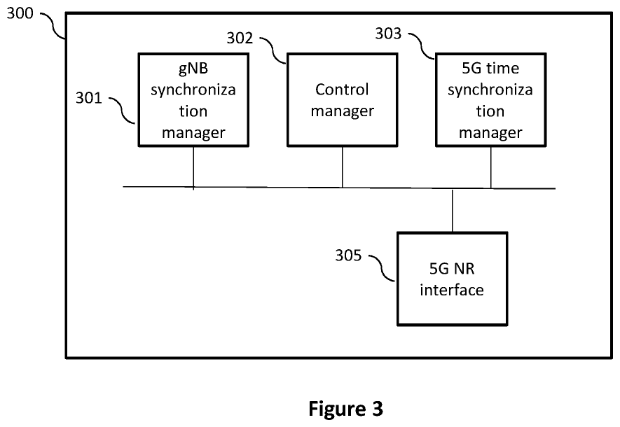

An exemplary and simplified internal architecture of the UEs 104a, 104b is illustrated in FIG. 3 by means of a diagram.

The UE 300 comprises a 5G NR interface 305 allowing the UE 300 to communicate through this interface with the gNB 200, 102. The UE 300 may comprise several different types of radio interfaces, such as LTE (4G) or other types of radio interfaces.

The synchronisation of the UE with the 5G GM clock is handled by a 5G time synchronisation manager 303.

According to some embodiments, the 5G time synchronisation manager 303 implements a time counter incremented by a local clock oscillator. The 5G time synchronisation manager 303 may correct or change the time counter value when receiving time counter corrections from the gNB synchronisation manager 301.

Indeed, the gNB synchronisation manager 301 stores parameters required for the synchronisation provided by the gNB 102 and determined by UE synchronisation manager 201 of the gNB 102. Besides, the gNB synchronisation manager 301 is also configured to evaluate and record propagation delays between the UE 300 and the gNB 102.

The UE 300 further comprises a control manager 302 in which the gNB control protocols are implemented. The control protocols comprise at least the following protocols: RLC (Radio Link Control TS 38.322), PDCP (Packet Duplication Control Protocol TS 38.323), RRC (Radio Resources Control TS 38.331) and NAS (Network Access Stratum TS 24.501). The control manager 302 handles the generation of the protocol packets exchanged with the gNB 200, 102 through the 5G NR interface 305.

The organisation of the exchanges of data between the 5G NR interfaces 205, 305 of the gNB and the UEs respectively comply with a system frame format specified by 3GPP NR PHY and MAC protocols, defined in TS 38.300 clause 5 and 6.

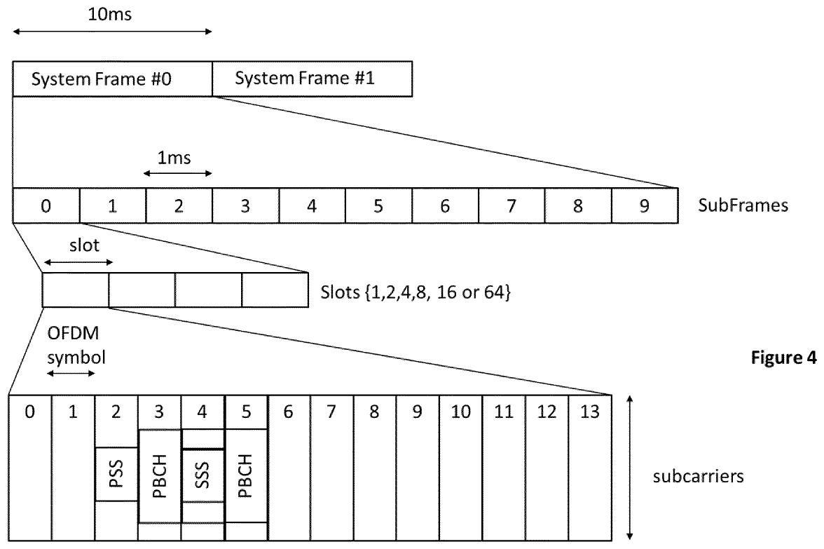

The system frames structuring the data exchanges are timely organized and have a structure as illustrated in FIG. 4. They are declared (or provided) by the gNB using appropriate signalling, for instance periodically through a SIB1 message.

The system frames follow each other temporally, one after the other. Each system frame has a duration of 10 ms. A cyclic code/prefix may be transmitted periodically by the gNB to declare the start of each system frame.

The system frames may be numbered with a System Frame Number (SFN), also called an index of the System Frame. As depicted in FIG. 4, the first system frame numbered #0 is followed by the system frames #1, #2 and #3. The numbering of the system frames may be done in increments. In other words, every 10 ms, the system frame number is incremented and may go from 0 to 1023, and once 1023 is reached, the numbering starts again from 0.

Thus, the gNB numbers the system frames with SFNs. The SFNs are signalled to the UEs using System Frame Synchronisation Signal or Synchronization Signal block (SSB). The SSB is made up of a Primary Synchronisation Signal (PSS), a Secondary Synchronisation Signal (SSS) and a Physical Broadcast Channel (PBCH) which are used by the UE to acquire time synchronisation in terms of symbol-level and slot-level and frequency synchronisation with a cell (comprising the gNB and the associated UEs).

Those synchronisation signals (PSS, SSS), sent by the gNB, help the UE to detect the frame and subframe boundaries. The SSB is periodically sent by the gNB to the UEs at predefined symbols during the system frames (at predefined instants in predefined resources of one or several subframes), by signalling the SFN using six most significant bits of a so-called MIB (Master Information Block) field and the four least significant bits of a so-called PBCH field.

Each system frame comprises ten subframes, ranged from 0 to 9.

Each subframe comprises a flexible number of slots, e.g. up to 64 slots. Each slot comprises several orthogonal frequency-division multiplexing (OFDM) symbols. Each slot is made up to 14 OFDM symbols. The symbols may be declared as uplink symbols (i.e. to be used by UEs for transmission) or downlink symbols (i.e. to be used by the gNB for transmission) or flexible (i.e. uplink or downlink). A resource allocation scheme providing the type declaration for each symbol is declared by the gNB, for instance in the SIB1 message. It defines the sequencing of uplink, downlink and/or flexible symbols within the slot or the subframe or the whole system frame.

The gNB may choose from amongst a plurality of predefined slot allocation schemes, as detailed in the standard TS38.213 in Table 11.1.1-1: Slot formats for normal cyclic prefix.

A cyclic prefix may be transmitted periodically by the emitter to protect against interference. The cyclic prefix may also declare the start and/or the end of each OFDM symbol.

Thus, the system frame constitutes a reference common to the UEs and the gNB to organise the frame exchanges. Therefore, system frames, in particular their SFNs, are used for a conventional adjustment of the time counters of the UEs.

The conventional time counter adjustment of a UE is illustrated in FIG. 5.

The conventional time counter adjustment relies on the supplying of a reference time value (T_{R}) to the UE for updating its time counter. The reference time value corresponds to a time at a reference time point of a system frame used as reference. It is below called reference system frame.

For example, the reference time corresponds to the projected time of the time counter of the gNB when the specific reference time point in the reference system frame occurs (e.g. at the end of a reference system frame). The specific reference time point is an accurate point in time which the UEs use for updating their time counter. According to implementations, the time counter may be updated at the reference time point, or a time offset is determined at the reference time point and the time counter is updated later using the determined time offset.

Thus, after receiving from the UE a request for a reference time value to update its time counter, or spontaneously, the gNB selects a future reference system frame comprising the reference time point at which the gNB will compel the UEs to update their time counter with the reference time value provided by the gNB.

The reference time point may be freely chosen by the gNB, for instance corresponding to the end boundary or the start boundary of the reference system frame. In a variant, it may correspond any predefined cyclic code/prefix (predefined symbol or symbols) or physical preamble or message (such as a reference frame or a synchronisation signal) transmitted by the gNB during the reference system frame or for signalling the start boundary of the next system frame.

According to some embodiments, it may be predetermined that the reference time point is the beginning or the end of the reference system frame. In this specific case, information relating to the reference time point only comprises information relating to the reference system frame, such as the number of the reference system frame (referenceSFN).

The reference time value may thus correspond to the time at the intended start or end time of the reference system frame, which may be inferred directly from any reference frame sent by the gNB to announce the start of the reference system frame or the start of the next system frame, or sent by the gNB during the reference system frame.

To simplify the description, it is assumed hereinafter that the reference time point is the end of the reference system frame (identified by its system frame number referenceSFN). Therefore, thereafter, information relating to the reference time point is merely the referenceSFN number.

As shown in FIG. 5, the reference time is equal to the sum of:
the current time of the time counter of the gNB, that is continuously synchronised with the 5G GM clock thanks to synchronisation manager 203; with
the duration T which represents the delay (in time counter units) the gNB will wait before reaching the reference time point during the reference system frame (e.g. the end thereof).

According to some embodiments where the reference time point corresponds to the end boundary of the reference system frame, the reference time may be for example determined by the gNB as the sum of:
the current time of the time counter of the gNB that is synchronised to the 5G Grand Master clock thanks to synchronisation manager 203;
the remaining time before the beginning of the next system frame. As a new system frame occurs every 10 ms, the remaining time may be obtained by the means of an alarm counter set to 10 ms at each start of a system frame and then decremented, and
10 ms*(referenceSFN−nextSFN+1), where reference is the SFN of the designated reference system frame and nextSFN is the SFN of the next system frame. Note that referenceSFN can be nextSFN if the reference time is calculated just before starting the reference system frame. In that case, the reference time is included in the reference system frame, and a SIB9 message can be used. Usually, referenceSFN refers to a reference system frame in the future, i.e. referenceSFN−nextSFN>0.

Reference time T_{R} and an indication of the reference system frame, referenceSFN for example, are then provided to the UEs. Both of these elements may be sent together or separately.

According to some embodiments, the gNB prepares an Information Element (referenceTimeInfo IE) containing reference time T_{R} and referenceSFN. The referenceTimeInfo IE is then encapsulated in a System Information (SI) or Radio Resource Control (RRC) messages, such as SIB9 or DLInformationTransfer messages.

DLInformationTransfer message is transmitted prior to the reference system frame, as shown in FIG. 5.

SIB9 message is transmitted during the reference system frame. It thus directly includes the reference time T_{R} concerning the reference time point comprised in the same reference system frame. Thus, no other message in relation with the reference system frame is transmitted before by the gNB.

As shown in FIG. 5, the gNB thus sends the message to the requesting UE or to several UEs if the message is a broadcast.

In case a DLInformationTransfer message is transmitted, later on, a reference frame is sent by the gNB to signal the reference time point of the reference system frame, when its time counter is equal to the reference time.

Again, in general, the reference frame may be cyclic codes or physical preamble starting the reference system frame, cyclic codes or physical preamble starting the next system frame (e.g. when the reference time point is the boundary between the reference system frame and the next system frame) or any message (e.g. synchronisation signal) transmitted during the reference system frame.

Once the reference time point of the reference system frame is detected by the UE(s) thanks to the referenceSFN and the reference frame, the UE (its managers 301 and 302) which has previously received the reference time T_{R} (or retrieves the reference time from the SIB9 message) sets its time counter to the reference time.

In the particular case of SIB9, the reference time corresponds to the time at the end boundary of the reference system frame.

As shown in FIG. 5, there is however a delay between the instant when the gNB transmits the reference frame and the instant when the UE receives it. This delay, also called the propagation delay, represents the time of propagation of the radio signals between the UE and the gNB.

Thus, the above-described synchronisation mechanism relies on the assumption that the propagation delay of the reference frame, used as a trigger by the UE to set its local time counter with the reference time supplied by the gNB, is negligible.

One can understand that a permanent synchronisation error due to the propagation delay of the gNB messages is introduced when the UE set its time counter using the reference time provided by the gNB. This may be not compatible with some applications (for instance Time Sensitive applications), in particular applications requiring an accurate timestamp of the arrival or departure time of some packets. Indeed, the permanent synchronisation error due to propagation delay introduces an error in the timestamping of those packets and that may be incompatible with the requirements of time-sensitive applications.

In order to overcome this drawback, it may be possible to take the advantage of the Precision Time Protocol (IEEE1588) adapted to 5G system for measuring, for instance periodically, the propagation delay between the user equipment and the base station during a position triangulation estimate.

The estimated propagation delay is then used to compensate the identified error. For instance, when setting the time counter to T_{R} upon detecting the reference time point, the UE may add the last estimated propagation delay to the time counter.

The Precision Time Protocol (PTP) adapted to 5G system is illustrated in FIG. 6a.

The PTP relies on the exchange of uplink and downlink measurements frames between the UE and the gNB, in order to estimate the round-trip time (RTT) by timestamping the times of transmission and reception at both the gNB and the UE. By using their time counter, the UE and the gNB registers the receiving and transmission times of the exchanged frames.

First, as shown in FIG. 6a, the UE transmits a first measurement frame, i.e. uplink frame #i, and records the transmission time t1 of that frame #i in an internal memory of the UE.

Next, upon receiving the first measurement frame #i, the gNB stores the receiving time t3 in an internal memory.

Next, the gNB transmits a second measurement frame, i.e. downlink frame #j to the UE, and records the transmission time t2 of the frame #j within the internal memory.

According to some embodiments, the transmission of the second measurement frame #j may occur before receiving the first measurement frame #i. According to some embodiments, the transmission order of the measurement frames #i and #j may be inverted.

Upon receiving the second measurement frame #j, the UE stores the receiving time t4 of the second measurement frame #j in its internal memory.

Once both measurements frames #i and #j has been received, the UE and the gNB respectively perform the following calculation: UE_{Rx-Tx}=t4−t1 and gNB_{Tx-Rx}=t2−t3. The obtained quantities UE_{Rx-Tx} and gNB_{Tx-Rx} are similarly signed (either positive or negative) when the measurement frames do not cross each other.

The gNB then provides the UE, using a subsequent (or follow-up) downlink frame, with the calculated value gNB_{Tx-Rx} as a parameter in order to allow the UE to determine the propagation delay between the UE and the gNB.

When receiving the subsequent downlink frame including the calculated value gNB_{Tx-Rx}, the UE then determines the propagation delay by subtracting gNB_{Tx-Rx} to UE_{Rx-Tx}:

Propagation delay=RTT/2=(UE_{Rx-Tx}−gNB_{Tx-Rx})/2 on the assumption that the propagation delay is the same for uplink and downlink transmissions.

The estimated propagation delay may then be added to the UE time counter when next setting the time counter to T_{R} upon detecting a next reference time point. In a variant, it may be used directly after estimation, to correct the time counter given the estimated propagation delay used when setting the time counter at the reference time point.

Thus, the consideration of the calculated propagation delay for updating the time counter of the user equipment is an improvement to achieve the strict end-to-end timing accuracy requirements of the time sensitive applications. Indeed, the calculated propagation delay is then used to compensate for the identified error, i.e. the propagation delay associated with the transmission of the reference system frame.

An alternative method for determining the propagation delay between the gNB and the UE may be used, known as Timing Advance (TA) mechanism and defined in the standard, in TS 38.211 clause 4.3. An example of the use of TA mechanism for determining the propagation delay is illustrated in FIG. 6b. This mechanism provides timing values within a Timing Advance (TA) command per user equipment which considers the propagation delay estimated for the user equipment.

To do that, the base station schedules the transmission time of an uplink frame by the user equipment and regularly monitors the propagation delay of this scheduled uplink frame, as it knows its transmission time and can detect its arrival time. In order to control the UE uplink timing, the gNB sends TA commands in control messages to the UEs of the network. A TA command is specific to a given UE because it reflects the propagation delay with this specific UE.

Upon receiving the uplink frame, the base station may compare the estimated propagation delay with a previously estimated one, in order to detect a significant increase in the propagation delay in comparison with the previously estimated one.

When a significant increase is detected, the base station sends a subsequent TA command to the user equipment in order to provide updated parameters, as illustrated in FIG. 6b.

The user equipment registers the parameters of the command, calculates an updated propagation delay and waits for the next reference system frame. Upon detecting the next reference time point, the user equipment determines an updated time counter based on the last calculated propagation delay, i.e. the calculated propagation delay is added to the time counter set to T_{R}.

TA commands are provided by the gNB to the UE through the 5G NR interface.

For the transmission, TA commands are encapsulated in different types of Protocol Data Unit (PDU), of the following types, all defined in TS 38.321:
Random Access Response MAC Protocol Data Unit (PDU) as defined in TS 38.321, clauses 6.1.5 and 6.2.3. RAR is a response frame to a Random Access Preamble used by the UE within the Random Access procedure for associating with a gNB. In RA procedure, propagation delay measurement is triggered by the UE by transmitting a Random Access Preamble to the gNB.
Absolute Timing Advance Command MAC Control Element or Timing Advance Command MAC Control Element, defined in TS 38.321, clause 6.1.3.4 and 6.1.4a;

At least two information are provided within the TA command: a parameter to determine the propagation delay (or the propagation delay itself) relating to a previously sent uplink frame.

The uplink frames may be of different types. In case where the TA command is in a Random Access Response, the uplink frame is a specific frame of the Random Access procedure. Otherwise, the uplink frame may be e.g. a Physical uplink shared channel (PUSCH), a Physical uplink control channel (PUCCH) or a Sounding Reference Signal (SRS) as defined in TS38.213.

According to the type of TA command, the provided parameters may be of different nature. In the case of the Random-Access Response and the Absolute Timing Advance Command, an absolute value of the parameter TA is provided. In the case of the Timing Advance Command, only a correction of a previously provided TA is included in the TA command.

Thus, according to some embodiments, the TA command may comprise an absolute value of TA in a TA command field, that is then used by the UE to determine the instant T_{TA} according to the following formula:

T_{TA}=(N_{TA}+N_{TA,offset})*T_{C}, where
N_{TA}=TA*16*64/20 and p is the subcarrier spacing configuration, Δf=2μ*15 kHz as defined in TS 38.211, clause 4.2, Table 4.2-1,
N_{TA,offset} is a fixed offset used to calculate the timing advance,
T_{C} is the Basic time unit for the New Radio as defined in TS 38.211, clause 4.1.

According to other embodiments, the TA command may comprise a correction, referred to as TA_{correction}, of a previously provided TA value, TAₚᵣₑᵥᵢₒᵤₛ. In this case, the adjustment to be applied to previous T_{TA} is equal to (TA_{correction}−31)*16*64/2^{μ}.

Interestingly, one may notice that the member N_{TA} is proportional to the round-trip time between the gNB and UE. Such a value N_{TA} may help to determine the propagation delay, assuming that the propagation delay is symmetrical. For instance, the propagation delay between the UE and gNB is equal to (N_{TA}*Tc)/2.

This way, when receiving a TA command, the UE may be able to determine the propagation delay during the transmission of the TA command. The calculated propagation value may be then used when adjusting the time counter as described hereinbefore, using the reference time T_{R} and the reference frame sent by the gNB.

However, the calculated propagation delay using PTP or TA mechanism may be estimated with a positioning of the UE different from the positioning of the UE when the reference frame (triggering the setting of the counter based on the reference time) is transmitted, assuming for instance that the UE is mobile relatively to the base station.

For example, in case the UE moves away from the gNB between the moment when the propagation delay is estimated and the moment when the reference frame signalling the reference time point is received, then the estimated propagation delay value will not be sufficient to compensate for the actual propagation delay when setting the time counter to T_{R}.

As the triangulation estimation is performed by the PTP on a periodic fashion that is triggered independently to the reference frame (or reference time point), the PTP is not adapted for accurately estimating the propagation delay when the UE is moving relatively to the gNB.

Similarly, as the TA mechanism is triggered independently to the reference frame, the TA mechanism is also not adapted for accurately estimating the propagation delay when the UE is moving relatively to the gNB.

There is thus a need to improve the correlation between the measurements of propagation delay and the reference frame used by the UE to synchronise its local time counter with the 5G system clock.

In a first aspect, the present invention thus proposes that the determination of the propagation delay at the UE is scheduled relatively to the reference time point of the reference system frame.

The reference time point of the reference system frame is thus used to schedule or trigger the measurement of the propagation delay (or the measurement of the RTT) as closely as possible to the reference time point, hence as closely as possible to the reference frame.

In this way, as the propagation delay estimation is temporally scheduled closer to the reference time point, the estimated propagation delay is as close as possible to the actual propagation delay occurring between the UE and the gNB at the reference time point.

Consequently, the updating of the time counter with the determined propagation delay is more accurate, and the error illustrated on FIG. 5 is reduced. The determination of the propagation delay is performed using an improved PTP method or an improved TA mechanism.

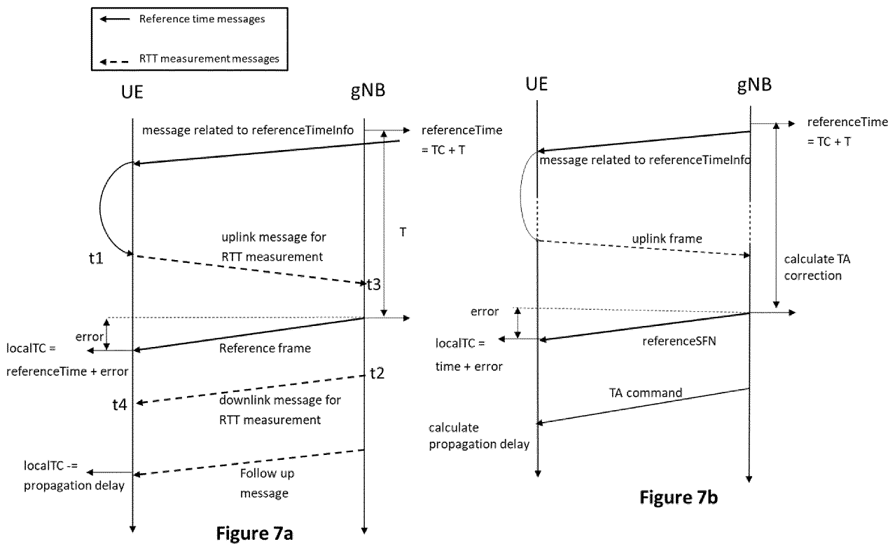

Several embodiments are proposed within the document, and are illustrated from FIGS. 7a to 11.

FIG. 7a illustrates a general principle of the invention based on an improved PTP method according to embodiments of the invention. The diagram of FIG. 7a illustrates frames exchanged between the UE and the gNB according to an embodiment of the invention. FIG. 7b illustrates another embodiment using the TA mechanism, where the uplink frame is scheduled as described below.

Thanks to the invention, the determination of the propagation delay occurs close to the reference time point associated with a reference time T_{R} for updating the time counter of the UE.

First, similarly to the procedure described in relation to FIG. 5, the gNB sends a downlink frame to the UE (in both FIGS. 7a and 7b). The downlink frame comprises information relating to the reference time point at which the UE shall update its time counter, in particular it comprises the SFN of the reference system frame as well as the associated reference time T_{R}.

In the present illustration, the reference time point is, for example and without limitation, the end of the reference system frame.

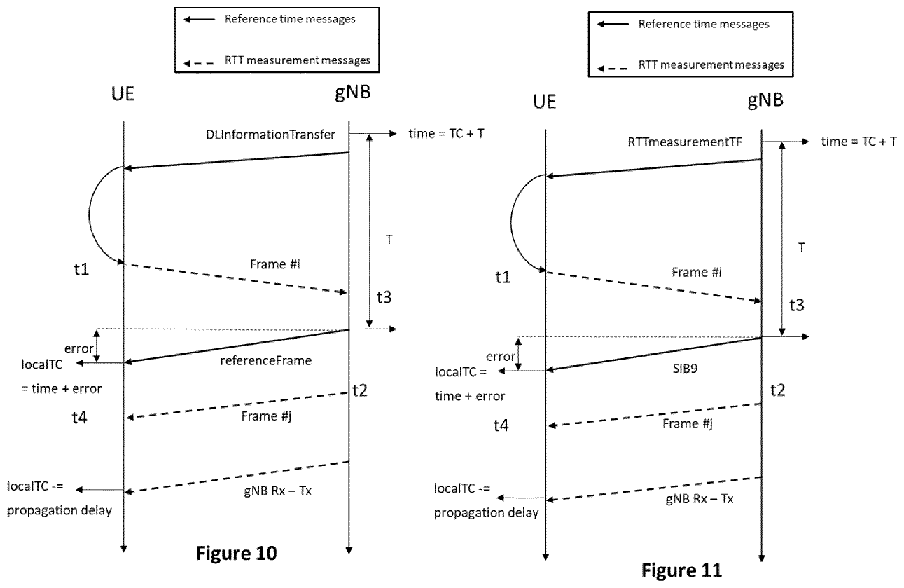

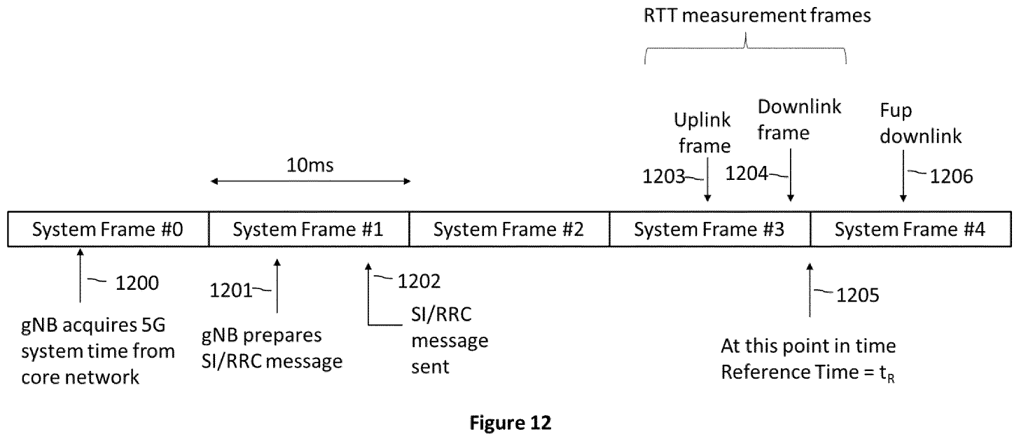

The downlink frame may be of two different types, DLInformationTransfer message or a SIB9 message. The description of the two embodiments described in relation to FIGS. 11 and 12 more precisely points out the specifics of using these types of messages.

Both of these types of messages may comprise, further to information relating to the reference time point, additional information.

Regardless of the type of the downlink message, its reception by the UE triggers the scheduling of the propagation delay measurement.

In order to update the time counter of the UE as accurately as possible, the UE schedules the propagation delay measurement temporally close to the reference frame signalling the reference time point. Thus, such a scheduled propagation delay measurement provides a close estimation of the propagation delay of the reference frame used by the UE to detect the reference time point. Indeed, this propagation delay is the cause of a possible desynchronisation of a time counter set only to the reference time.

Therefore, the UE schedules the determination of the propagation delay relatively to the reference time point, as known from the previously received downlink frame. In other words, based on the information contained in the previously received downlink frame relating to the reference system frame (i.e. the target frame for the updating of the time counter) and the current time, the UE schedules the start of the propagation delay measurement.

The scheduling of the measurement of the propagation delay may comprise scheduling the time of transmission of the first and (optionally) the second measurement frames as described hereinbefore in relation to FIG. 6a or 6b. The first measurement frame may be either the first measurement frame used in the PTP method or the uplink frame of the TA mechanism. With the TA mechanism, no second measurement frame is needed, as the gNB determines the propagation delay only using one uplink frame.

Advantageously, the scheduling time of the transmission of the first measurement frame is determined based on a resource allocation scheme previously provided the gNB. The determination of the resource allocation scheme is further explained in relation with the second aspect of the invention.

According to some embodiments, the scheduling of the propagation delay measurement comprises the determining of a time to initiate the determining of the propagation delay, e.g. the transmission time of the first measurement frame. This is for instance the case in the scenario of FIG. 7a.

The time to initiate the propagation delay measurement is thus based on the SFN of a current system frame, a current value of time counter and the SFN of the reference system frame.

To do that, according to some embodiments, a timer may be used to generate the time to initiate the determining of the propagation delay (or the RTT) when it counts down to zero from a threshold or counts up to a threshold. The threshold may be determined by the UE using the difference between the SFN of the current system frame (when receiving the DLinformation message) and the SFN of the reference system frame and using the system frame periodicity (usual value of 10 ms, as previously mentioned) to set its timer: timer value (threshold)=current time+time to next system frame+10 ms*(referenceSFN−SFN of next system frame).

Thus, according to some embodiments, once the threshold is determined, a decrementing timer is set to the determined threshold as an initialisation time. Then, the determination of the propagation delay is initiated when the decrementing timer expires.

According to some TA-command based embodiments, the scheduling of the uplink frame may be provided by the gNB. In other words, the gNB may provide the UE with information relating to the transmission time of the uplink frame (i.e. the first measurement frame). In that case, the UE only sets its timer so that it elapses at the provided scheduling time. According to the invention, this scheduling time so provided is close to the reference time point.

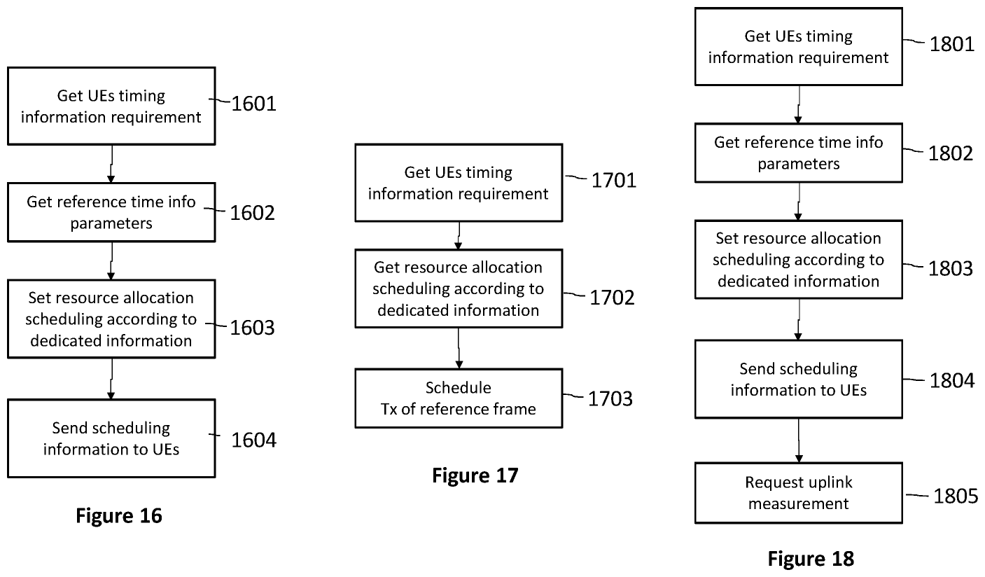

In the TA-command based mechanism, upon the determination of the reference time, the gNB may allocate a resource to the UE for the sending of the uplink frame (i.e. the first measurement frame), relatively close to the reference time point. The allocated resource is thus signalled within the resource allocation scheme sent by the gNB to the UEs. Thus, the UE infers the transmission time of the first measurement frame from the resource allocation scheme by retrieving an uplink resource allocated to it for an uplink frame. The transmission of the resource allocation scheme by the gNB to the UE is further explained in relation to the second aspect of the invention, notably, in relation with step 1604 of FIG. 16.

At the expiration of the timer, the UE transmits a first measurement frame (that is an uplink message) to the base station, as visible in both FIGS. 7a and 7b. Besides, the UE stores a time of transmission t1 of the first measurement frame. The time of transmission is the value of the time counter when the UE transmits the first measurement frame.

In the illustrated example, the first measurement frame is scheduled to be transmitted during the reference system frame but before the reference time point. Of course, it may be transmitted in other system frames, for instance the one preceding, preferably immediately preceding, the reference system frame. Alternatively, it may be scheduled to be transmitted during a system frame (immediately or not) following the reference system frame.

Next, the gNB receives the first measurement frame, and stores a time of receiving t3 of the first measurement frame by the gNB. The time of receiving is the value of the time counter of the gNB when the first measurement frame is received by the gNB.

Then, the gNB sends a reference frame during the reference system frame. The reference frame signals the reference time point. It may be cyclic codes/prefixes or physical preamble or synchronisation signals declaring either the start of the reference system frame (in which case the reference time point is 10 ms later) or the start of the system frame immediately following the reference system frame (in which case the reference time point is the start of this system frame). It may also be a message emitted at the reference time point, e.g. ending the reference system frame.

As illustrated, upon detecting the reference time point of the reference system frame, the UE updates its local time counter with the reference time T_{R} provided by the gNB and associated with the reference system frame.

Next, the gNB transmits the optional second measurement frame to the UE and records the transmission time as t2 of the second measurement frame.

According to some embodiments, and as illustrated in FIG. 7a, the second measurement frame is sent during a system frame (immediately or not) following the reference system frame.

According to some embodiments, the second measurement frame is transmitted during the system frame immediately preceding the reference system frame. This advantageously allows the delay propagation estimation to be finished before the reference time point.

According to some embodiments, the second measurement frame is scheduled to be transmitted during the reference system frame. In particular, the second measurement frame may be the reference frame signalling the reference time point for the UE.

According to some embodiments, the transmission time of the second measurement frame is scheduled relatively to the reference time point. For example, the transmission time of the second measurement frame may be scheduled before or after the reference system frame. Similarly to the scheduling of the transmission time of the first measurement frame, a timer may be used at the gNB to manage the transmission time of the second measurement frame. The threshold of the timer may be determined by the gNB using the SFN of the current system frame (when transmitting information relating to the reference time point), the referenceSFN and the system frame periodicity (usual value of 10 ms, as previously mentioned) to set its timer.

Therefore, the gNB, in parallel to the declaration of the reference system frame and of the reference time point, also schedules the transmission of the second measurement frame and set accordingly the timer. At the expiration of the timer, the gNB therefore sends the second measurement frame. Using a timer has the benefit to be a reliable solution if the gNB is quickly responsive to the receiving of the first measurement frame in order to trigger the sending the second measurement frame.

Upon the receiving of the second measurement frame by the UE, the UE records the time of receiving as t4 of the second measurement frame.

The RTT or the propagation delay can then be determined in the same way as described above in relation with FIG. 6a or 6b.

The difference gNB_{Tx-Rx}, or t3 and/or t2 may be transmitted to the UE in a follow-up message.

According to some embodiments, the gNB transmits the value t2 to the UE, directly into the second measurement frame. To do that, the transmission time t2 may be known in advance because scheduled relatively to the reference time point, so that t2 is directly included in the second measurement frame or the gNB may support the timestamp insertion on the fly after the timestamp point. In that case, no follow-up message is required.

Then, the UE calculates the RTT or the propagation delay between the UE and the gNB with the following calculations: RTT=UE_{RX-Tx}−gNB_{Tx-Rx} or delay propagation=(UE_{RX-TX}−gNB_{TX-RX})/2, on the assumption that the propagation delay is the same for the uplink and downlink transmissions.

In the TA-based mechanism, no second measurement frame is transmitted. As shown in FIG. 7b, the gNB provides the UE with a transmission time to schedule transmission of the uplink measurement frame based on the provided reference time by the gNB. Next, the gNB estimates the propagation delay from the receiving of this uplink measurement frame sent by the UE. Thus, the gNB only uses a follow-up message (i.e. a subsequent TA command or the like) to transmit information relating to the value of the estimated propagation delay. Therefore, the UE calculates the propagation delay based on the received information. According to some embodiments, the follow-up message is a generic follow-up message directly comprising the value of the estimated propagation delay. Such a message enables the reduction of calculations at the UE.

Next, the UE updates its local time counter with the calculated value of the propagation delay. This allows to compensate for the error introduced when the UE has previously updated (or set) its time counter based on the reference time associated with the reference system frame. To do that, the calculated propagation delay is added to the time counter previously set to T_{R}.

In the example illustrated in FIG. 7a, the first and the second measurement frames are sent respectively before and after the reference system frame.

According to some embodiments, the order of transmission of the first and the second measurement frames may be inverted: in this case, the second measurement frame is scheduled relatively to the reference time point.

According to some embodiments, both the first and second measurement frames are sent and received before or after the reference system frame.

Further, according to some embodiments, the first measurement frame and/or the second measurement frame may be sent during the reference system frame.

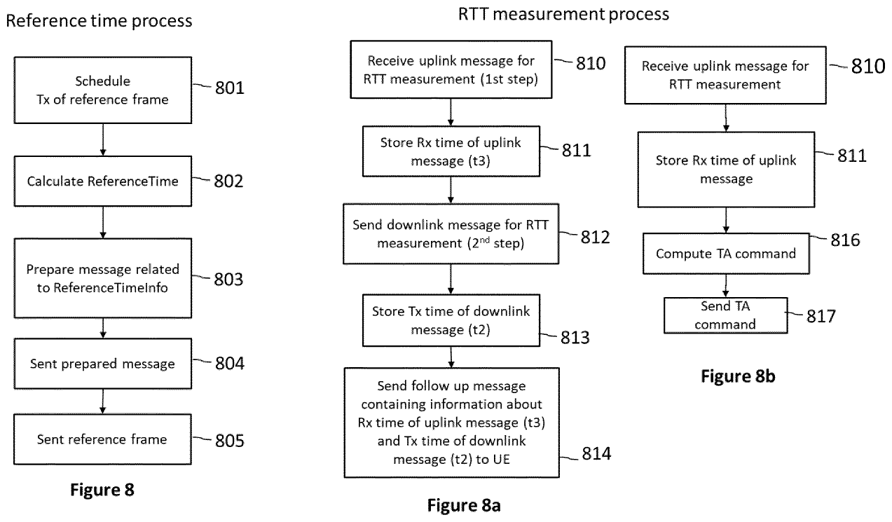

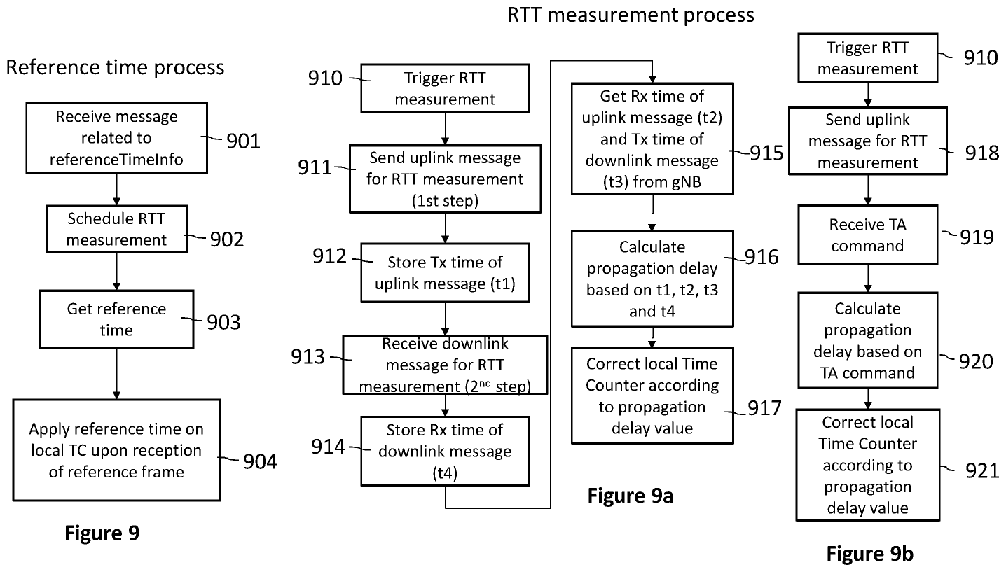

For better understanding, the method proceeding at the gNB side and at the UE side, is further detailed respectively in relation to FIGS. 8, 8a, 8b, 9, 9a and 9b.

In the illustrated embodiment, the reference time point is the end of the reference system frame. Therefore, in this embodiment, information relating to the reference time point is referenceSFN.

FIG. 8 illustrates, at the gNB, the corresponding method for updating the time counter of the UE with a reference time T_{R} and FIGS. 8a and 8b, illustrate alternatives of the corresponding method for compensating the propagation error introduced during the updating of the time counter of the UE. These methods are performed by the UE synchronisation manager module 201 of the gNB.

The method for updating the time counter of the UE at the gNB comprises first step 801 that aims at scheduling the reference system frame.

Next, at step 802, the gNB calculate the reference time T_{R}, as explained in relation to FIG. 5.

Next, at step 803, the gNB prepares a message to provide information relating to the reference system frame to the UE. For example, the message comprises Information Element containing for example the referenceSFN.

This message has two uses according to the invention:
it aims at announcing a new reference time point in advance to the UE, together with the associated reference time T_{R};
it triggers the scheduling of the measurement of the propagation delay between the gNB and the UE, such that the UE schedules the propagation delay measurement in proximity to the reference time point.

The message may be either a dedicated RRC message or a dedicated MAC CE or in SIB or DLinformationTransfer message.

The prepared message containing information relating to the reference system frame is then sent at step 804 by the gNB to the UE. The message may also contain the reference time T_{R}.

At step 805, the gNB sends a reference frame to signal the reference time point of the reference system frame, using its 5G NR interface 205. This may be cyclic codes or physical preamble or synchronisation signals signalling the start of the reference system frame or the start of the immediately following system frame.

FIG. 9 illustrates, at the UE side, the corresponding method for updating the time counter of the UE with the reference time and FIGS. 9a and 9b, illustrate alternatives of the corresponding method for compensating the propagation error introduced during the updating of the time counter of the UE. These methods are performed by the gNB synchronisation manager module 301 of the UE.

The method for updating the time counter of the UE at the gNB comprises at first step 901, the receiving, through its 5G NR interface 305 of the message sent by the gNB at step 804 providing information relating to the reference time point: referenceSFN and T_{R}.

Next, at step 902, the UE extracts information relating to the reference time point in order to schedule the determining of the propagation delay relatively to the reference time point and the current time. Therefore, the UE may schedule the determining of the propagation delay using referenceSFN provided in the received message as described in FIGS. 7a and 7b.

The scheduling may comprise the setting of a timer to expire at the same time as the reference system frame starts for instance. Of course, the timer to transmit the first measurement frame may be set to another time close to the reference time point. It is thus initialized with the sum of:
The current time of the time counter of the UE;
The remaining time before the beginning of the next system frame. As a new system frame occurs every 10 ms, the remaining time may be obtained by the means of an alarm counter set to 10 ms at each start of a new system frame; and
10 ms*(target SFN index−next SFN index), where targetSFN is the SFN of the system frame when the propagation delay determination has to start, preferably the reference system frame, and nextSFN is the SFN of the system frame following the current system frame.

In a variant, the scheduling may comprise the setting of a timer to expire before the occurrence of the reference system frame. It is thus initialized with the sum of:
The current time of the time counter of the UE;
The remaining time before the beginning of the next system frame;
10 ms*(target SFN index−next SFN index−1); and
targetSubframes×1 ms, where targetSubframes is the identifier (from 0 to 9) of one of the 10 subframes forming the preceding system frame. The first measurement frame will thus be sent during this subframe.

Next, at step 903, the UE retrieves the reference time T_{R} from the message received at step 901.

According to some embodiments, the reference time T_{R} is previously sent simultaneously to an indication of the reference time point at step 901. In this case, the sent message at step 901 is for example a DLInformationTransfer message that comprises an IE referred as referenceTimeInfo, comprising both the reference time and the indication to the reference time point (such as referenceSFN). This case is illustrated in FIG. 10.

According to some embodiments, the reference time T_{R} may be received during the reference system frame. In this case, the sent message is for example a SIB9 message, as illustrated in FIG. 11.

Next, upon the detection of the reference time point (e.g. one of the boundaries of the reference system frame deduced from the reference frame sent by the gNB at step 805), the UE uses the reference time T_{R} to set its time counter, in order to synchronise it with the time counter of the gNB. As explained in relation to FIG. 5, unfortunately, this procedure introduces an error due to propagation delay of the reference frame signalling the reference time point to the UE.

The two propagation delay measurement methods as illustrated in FIGS. 9a and 9b at the UE side aims at determining a propagation delay value to compensate for the identified error. The method is performed by the gNB synchronisation manager module 301 of the UE.

Each alternative method corresponds to alternative approach for determining the propagation delay, PTP based or TA-based approaches. According to the chosen approach, the corresponding method may be used in combination with the method for updating the time counter of the UE as illustrated in FIGS. 8 (at gNB side) and 9 (at UE side).

First, at step 910, the UE is triggered to initiate the propagation delay measurement by the expiry of the timer set at step 902.

The UE sends, as scheduled, a first measurement frame to the gNB at steps 911 or 918 through its 5G NR interface 305. The transmission time t1 of the first measurement frame is stored (at step 912).

In the PTP approach, according to some embodiments, the first measurement frame may be a message dedicated to RTT measurement, and may comprise an indication of the RTT measurement purpose.

In both approaches, according to some embodiments, the first measurement frame may be any uplink message sent as closely as possible to the reference time point (before, during or after the reference system frame). In this case, the gNB may switch into an active measurement mode from step 804, in order to process each received uplink for propagation delay measurement.

Back to the gNB, two alternative methods illustrated in FIGS. 8a and 8b respectively corresponding the alternative methods of FIGS. 9a and 9b. At the gNB side, at step 810, the gNB receives the first measurement frame through its 5G NR interface 205.

At step 811, then the gNB stores the receiving time of the first measurement frame as t3.

At step 812, the gNB sends a second measurement frame, whose sending may be scheduled relatively to the reference time point, or may be triggered by the receiving of the first measurement frame.

According to some embodiments, the second measurement frame may be message dedicated to RTT measurement, and may comprise an indication of the RTT measurement purpose.

According to some embodiments, the second measurement frame may be any downlink message sent as closely as possible to the reference time point (before, during or after the reference system frame).

According to some embodiments, the second measurement frame may be transmitted during the reference system frame.

Next, at step 813, the gNB stores the transmission time t2 of the second measurement frame sent at step 812. As explained before, the transmission time t2 may be for example the reference time point or the start of the reference system frame or of a next system frame.

Back to the UE, at step 913, the UE then receives the second measurement frame sent by the gNB at step 812. The receiving time t4 of the second measurement frame by the UE is stored, at step 914.

In the TA-based approach, no second measurement frame is required. Thus, at step 815, the gNB stores the receiving time of the first measurement frame. Therefore, the corresponding processing step are not performed.

Back to the gNB side, at step 814, the gNB sends to the UE a follow-up message containing information relating to the receiving time t3 of the first measurement frame and the transmission time t2 of the second measurement frame. The information may be either the values of the times t3 and t2 in separate fields or more efficiently the time difference gNB_{Tx-Rx} between t2 and t3.

According to some embodiments, the follow-up message only contains information relating to the transmission time t2 of the second measurement frame. In this case, the information relating to the receiving time t3 of the first measurement frame may be previously sent to the UE, for instance within the second measurement frame.

According to some embodiments, there is no follow-up message. In this case, the second measurement frame directly contains information relating to the receiving time t3 of the first measurement frame and the transmission time t2 of the second measurement frame (or merely the difference gNB_{Tx-Rx}).

In the TA-based approach, the follow-up message sent at step 817 is merely a subsequent TA command comprising information relating to a propagation delay estimated by the gNB at step 816 by comparing the receiving time (from step 815) with the transmitted transmission time. For instance, this information may include a delay propagation correction that corrects the current delay propagation known by the UE and the gNB. According to some embodiments, the follow-up message may be a generic follow-up message directly comprising a value of the estimated propagation delay.

Back to the UE side, at step 915, the UE obtains, from the gNB, information relating to the receiving time t3 of the first measurement frame by the gNB and the transmission time t2 of the second measurement frame (or merely the difference gNB_{Tx-Rx}).

This information may be comprised in the follow-up message sent at step 814 or partially or entirely comprised in the second measurement frame.

Next, at step 916, as explained hereinbefore, the propagation delay is deduced.

In the TA-based approach, the estimated propagation delay may be retrieved (step 920) directly from the follow-up message (TA command), received at step 919.

Thus, at steps 917 or 921, the calculated value of the propagation delay is then used to correct the time counter of the UE (by adding thereto the estimated propagation delay), in order to compensate the error due to the propagation delay of the reference frame used to detect the reference time point.

Thus, the accuracy of the updating of the time counter is improved, thanks to the consideration of the propagation delay of the reference system frame.

According to some embodiments, steps 810 to 814 and 910 to 917 of the propagation delay measurement may be performed before or after the reference system frame. In other words, the propagation delay measurement may be scheduled such that the transmission and the receiving of both the measurement frames are performed before or after the reference system frame. In this case, according to some embodiments, steps 904 and 917 may be performed simultaneously, such that the time counter is updated with the sum of the reference time and the measured propagation delay.

FIGS. 10 and 11 illustrate alternatives of previously presented methods to improve the accuracy of the updating of the local time counter of an UE.

As explained hereinbefore, the scheduling of the propagation delay measurement is triggered upon the UE receiving a message containing information relating to the reference time T_{R} for setting its local time counter. This message may be of different types.

FIG. 10 illustrates an embodiment in which the message is a DLInformationTransfer as defined in the standard TS 38.331, item 5.7.1.

The DLInformationTransfer message may at least comprise information relating to the reference time point, to enable the UE to determine when to set its time counter to the reference time T_{R}. Thus, the information relating to the reference time point may be comprised in an Information Element (IE) called referenceTimeInfo within the DLInformationTransfer message.

According to some embodiments, this information may comprise the referenceSFN. According to some embodiment, this information may comprise information relating to a precise reference time point (e.g. the beginning or the end of the reference system frame) of the reference system frame when the UE shall update its time counter with the reference time T_{R}.

According to some embodiments, DLInformationTransfer message may further comprise information relating to the reference time T_{R}, in the Information Element (IE) called referenceTimeInfo. As explained before, the reference time is used by the UE for updating its time counter. In this case both information relating to the reference time and the reference time point are included in the referenceTimeInfo.

According to some embodiments, the reference time T_{R} is transmitted separately from the reference time point (here referenceSFN value), within a frame distinct from the DLInformationTransfer message.

FIG. 11 illustrates an embodiment in which the message containing information relating to the reference time T_{R} is of a new type defined for the purpose of the invention, called hereinafter RTTmeasurement Trigger Frame (RTTmeasurementTF).

The RTTmeasurement Trigger Frame is sent by the gNB in order to trigger the scheduling of the propagation delay measurement relatively to the reference time point provided in the RTTmeasurement Trigger Frame. Thus, the reference time point, i.e. the moment when the UE shall set its local time counter to T_{R}, is then provided within the RTTmeasurementTF.

Information relating to the reference time point may comprise the referenceSFN value.

In the TA-based approach, the RTTmeasurementTF may directly include a time for the UE to transmit the first measurement frame.

Similarly to the previously presented embodiments, the measurement frames are then scheduled and sent temporally close to the reference system frame and reference time point.

The reference time T_{R} associated with the reference time point provided by the RTTmeasurementTF is transmitted during the reference system frame, for instance using a SIB9 message. In the particular case of SIB9, the provided reference time T_{R} corresponds to the end boundary of the reference system frame.

Therefore, when receiving the SIB9 message containing the reference time T_{R}, the UE sets its time counter with the reference time at the end of the reference system frame.

In both embodiments, the receiving of a DLInformationTransfer or SIB9 message triggers the scheduling of the propagation delay measurement close to the reference time point of the reference system frame. Therefore, the measurement frames #i and #j are then sent closely to the reference time point, such that the determined propagation delay reflects more accurately the propagation delay of the reference frame signalling the reference time point.

Therefore, the proposed method discloses a new usage of DLInformationTransfer or SIB9 messages in order to improve the accuracy of the updating of the time counter of the UE.

As detailed in FIGS. 7a to 11, in the first aspect of the invention, the first and second measurement frames and the follow-up message are scheduled temporally close to the reference time point, hence close to the reference frame subject to the propagation delay error.

An example of the temporality of the measurement frames and the follow-up message is better illustrated in FIG. 12. This figure shows the decision (1200) of the gNB to trigger a new reference time point (1205), the preparation (1201) of the message containing information relating to the reference time T_{R} and the sending (1202) thereof.

The reference time point is here chosen as the end of reference system frame #3. As explained hereinbefore, messages for measuring the propagation delay between the UE and the gNB, are sent temporally close to a reference frame 1205 signalling the reference time point associated with the time reference T_{R}.

At the reference time point 1205, the UE updates its time counter with the reference time value T_{R} previously provided within message 1202 by the gNB.

As shown in FIG. 12, the first and second measurement frames 1203 and 1204 are sent during the reference system frame #3. A follow-up message 1206, comprising the time of arrival of the first measurement frame and/or the time of transmission of the second measurement frame (or the difference between them), is sent by the gNB to the UE during the system frame #4 immediately following the reference system frame #3. This scenario is of course only an exemplary scenario as already mentioned above.

In the TA-based approach, only one measurement frame, an uplink frame 1203 is sent, such that only an uplink resource close to the reference time point is needed to estimate the propagation delay. The uplink frame may be for example, and without limitation, an uplink signal of the following types: Physical uplink shared channel (PUSCH), Physical uplink control channel (PUCCH) or Sounding Reference Signal (SRS) as defined in TS38.213. Further, in this approach for providing the UE with information relating to the propagation delay, a TA command is sent. The TA command requires a downlink resource.

Both of these methods rely on the exchange of messages between the gNB and the UE.

Resource allocation for transmitting these messages, the first and optional second measurement frames and the follow-up message (for the PTP-based approach or the TA-based approach), is performed by the gNB. By resource allocation, one should understand the determining of the opportunities for sending uplink or downlink frames within the system frames. According to the situation, the gNB may declare more or fewer opportunities for sending uplink frames.

As explained in relation to FIG. 4, the system frames are subdivided in the time domain and/or in frequency domain, such that each symbol sets the minimal duration at a given frequency for sending data. Before the start of a reference system frame, the gNB may determine which resource (time slots and/or OFDMA symbols) are allocated to uplink or downlink transmissions and their sequencing within the system frame according to a resource allocation scheme.

By efficiently selecting appropriate resource allocation schemes, the gNB can make it possible for these messages to be sent temporally close to the reference time point, hence close to the reference frame signalling the reference time point. In other words, opportunities to send the first measurement frame (uplink frame) and the optional second measurement frame (downlink frame) close to the reference time point can be ensured.

Thus, there is a need to ensure that the propagation delay measurement initiated by the UE is consistent and compatible with the resource allocation scheme selected by the gNB.

Therefore, according to a second aspect of the invention, in order to send and/or receive information to determine a propagation delay with the UE, the gNB selects at least one resource in a system frame relatively to the reference time point of the reference system frame and selects, for each selected resource, a suitable resource allocation scheme. Then, the gNB performs a propagation delay measurement by exchanging at least one measurement frame in the selected resource or resources. As shown in exemplary FIG. 12, the gNB can provide uplink and downlink symbols in reference system frame #3 while downlink symbols should be provided in subsequent system frame #4 (for the follow-up frame).

FIG. 16 illustrates a first embodiment of the method according to the second aspect of the invention wherein the resource allocation scheme is determined by the gNB based on the reference time T_{R} (and thus the reference time point).

First, at step 1601, the gNB determines the requirements regarding the synchronisation needed by the UE of the 5G network. According to the synchronisation requirements of the UE, the accuracy of the propagation delay may vary. The gNB may determine these requirements upon the reception of information provided by the UE, for instance in RRC message defined in the TS 38.331, in particular in UEAssistanceInformation message. The gNB may also infer these requirements based on QoS related information time such as sensitive communications (TSC) assistance information.

Next, at step 1602, the gNB determines, as explained in relation to FIG. 7a or 7b, the time reference T_{R} and the associated reference time point (e.g. through the referenceSFN value) to be provided to the UE for updating its time counter. Both information may be provided to the UE together or separately, as previously explained.

Although not illustrated in the diagram of FIG. 16, it is recalled that this information is transmitted to the UE and then the gNB transmits a reference frame to signal the reference time point associated with the reference time T_{R}. This allows the UE to set its time counter to T_{R}.

Based on the reference time and the associated reference time point (i.e. the frame to signal the reference time point), and the requirements regarding the synchronisation, at step 1603, the gNB selects at least one resource relatively to the reference time point. The resource may be defined in time and/or frequency within one or several slots or one or several subframes or a system frame close to the reference time point. The selected resources are for sending and receiving measurement frames close to the reference time point in order to determine the propagation delay between the gNB and the UE.

Further at step 1603, the gNB then selects a resource allocation for the selected resource. The resource allocation may be a time-based or frequency-based resource allocation. The resource allocation defines the allocation of the elements of the selected resource to uplink or downlink transmissions or both. The elements of the resource may be of different types such as symbols or carriers, slots (if the selected resource is a subframe or a system frame), subframe (if the selected resource is a system frame).

The gNB thus selects a resource allocation scheme providing uplink and/or downlink elements of the selected resource for the transmission and receiving of the measurement frames compliant with the synchronisation requirements of the UE.

For example, with the PTP-based approach, the gNB thus selects a resource allocation wherein:
at least one uplink element, close to the reference time point, is provided for the first measurement frame; and
at least two downlink elements, close to the reference time point, are provided for the second measurement frame and the follow-up message.

For example, with the TA-based mechanism, the gNB thus selects a resource allocation scheme wherein one or more uplink elements of the resource are provided for the transmission of at least one first measurement frame, regardless of whether some elements are allocated as downlink resources.

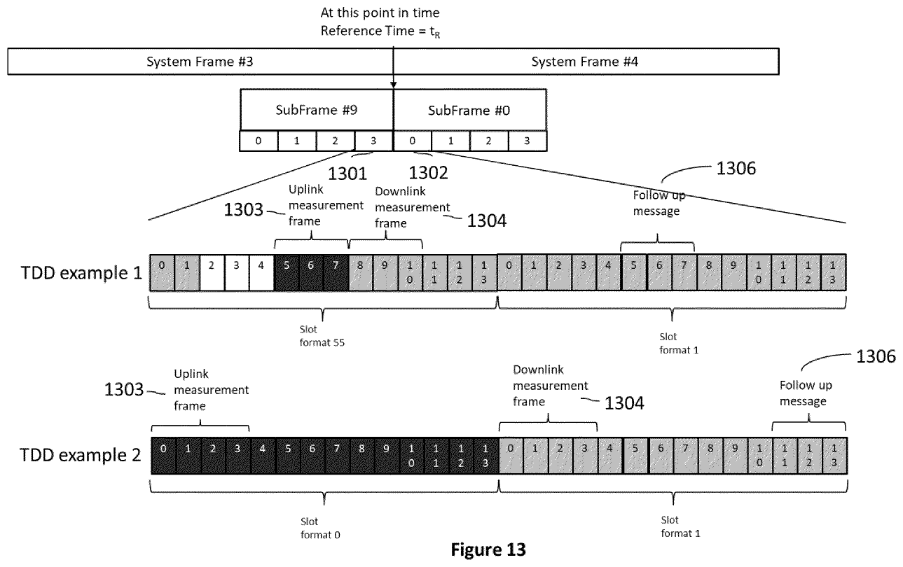

For example, the gNB selects as a resource one slot and thus an associated slot allocation scheme as a resource allocation scheme, as illustrated in FIG. 13.

The selection of these resources aims at enabling the exchange of measurement frames to determine the propagation delay close to the reference time point. In some embodiments, multiple resources (e.g. slots) are selected to convey the measurement frames.

To do that, first the gNB selects at least one resource relatively to the reference time point. Indeed, the gNB selects a resource close to the reference time point, during which measurement frames and the follow-up message may be sent.

Then the gNB selects, for the selected resources, resource allocation schemes.

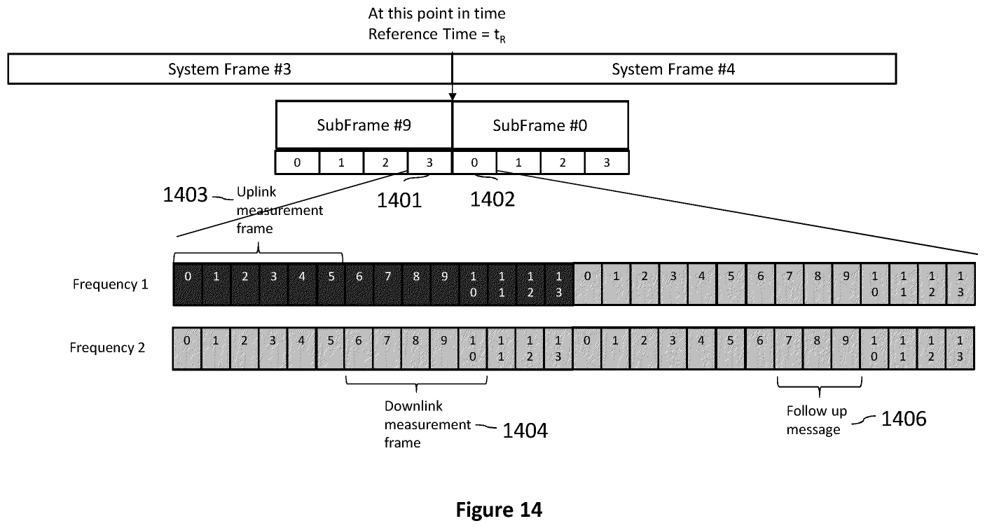

For instance, several predefined slot allocation schemes exist and are defined in the standard TS38.213, Table 11.1.1-1. In each predefined slot allocation scheme, it is provided for each slot the sequencing of uplink and/or downlink symbols within the slot (see hereinafter in reference to FIGS. 13, 14 illustrations of predefined slot allocation schemes 0, 1, 55).

According to some embodiments, the selected resource allocation scheme may comprise at least one uplink symbol, preferably multiple uplink symbols to provide the UE with uplink resources to transmit the first measurement frame. Such at least one uplink symbol may be thus used by the gNB to receive at least one measurement frame sent by the UE.

According to some embodiments, the selected resource allocation scheme may comprise at least one downlink symbol, preferably multiple downlink symbols to allow transmission of the second and/or follow up measurement frame by the gNB. Such at least one downlink symbol may be thus used by the gNB to transmit at least one measurement frame to the UE. Two different resources (possibly in different system frames) allocated to downlink may be used to convey the second measurement frame and the follow-up message respectively.

In TA-based mechanism, the selected resource allocation scheme may comprise at least one downlink symbol, for the sending of a subsequent TA command (equivalent to the follow up measurement message). Except when the TA command is of MAC CE type, allocated downlink resource is specific to the TA.

Therefore, the gNB selects the resource allocation scheme in order to provide uplink and downlink resources (e.g. symbols) for the transmission and receiving of the measurement frames compliant with the synchronisation requirements of the UE. The higher are the synchronisation requirements for the UE, the closer to the reference time point the measurement frames should be exchanged.

Next, at step 1604, the gNB declares the selected resource allocation scheme by sending to the UE the selected resource allocation scheme.

According to the chosen approach for determining the propagation delay (TA-based approach or PTP approach), the resource allocation may involve specific configurations.

For example, in the TA-based approach, the measurement frames may be PUSCH and PUCCH signals. gNB may reserve resources of the PUSCH channel dedicated for data that the UE wants to share with the gNB or resources of the PUCCH channel dedicated for control frames (e.g. acknowledgment frames).

The gNB may use then the parameters for configuring both PUSCH and PUCCH channels are defined in TS38.331 and are respectively PUSCH-config et PUCCH-config. Additional configuration parameters exist for the PUCCH channel, called PUCCH Resource Sets defined in Ia TS 38.213 section 9.2.1 for refine the resource allocation of PUCCH channel, previously provided by the gNB.

The declaration of the resource allocation scheme should then be sent to the UE before the beginning of the propagation delay measurement.

The configuration of the resource (i.e. the resource allocation schemes selected for the resources such as slots, symbols, etc.) may be provided to the UE through several ways.

For example, it may be supplied to the UE using a SIB1 messages as defined in the standard TS 38.331 section 6.2.2, periodically sent by the gNB, at least every 160 ms. For instance, a SIB1 message may be used.

Also, the configuration may be supplied to the UE in the Physical Downlink Control Channel (PDCCH) which is comprised at the beginning of each downlink subframes (i.e. subframes having only downlink symbols). The PDCCH, that one can considers as a control message, comprises downlink Control Information (DCI) that may be of different formats. Several DCI formats exist, as defined in the standard TS38.212 section 7.3, and a type of format of DCI may also indicate the slot allocation scheme of the subframes. This is the case for instance for the DCI format DCI 2_0 as defined in the standard defined in TS38.213 section 11.1.1. Some DCI contains frequency domain resource assignment and time domain resource assignment which allow the definition of the resource allocations in time and frequency for instance DCI format 0 also called UL grant.

Additionally, the configuration may be supplied to the UE via RRC message RRCreconfig including the IE called ConfiguredGrantConfig for time and frequency allocation. The frequency allocation may also be defined, in the FrequencyInfoUL and FrequencyInfoDL parameters (defined in TS 38.331).

In the TA-command based approach, the declaring of the selected resource allocation scheme (i.e. the sending to the UE of the selected resource allocation scheme) may be also use by the gNB to provide information relating to the transmission time of the first measurement frame used by the UE during the delay propagation determining. For instance, the gNB allocates one or more uplink resources to the UE in vicinity of the reference time point. Therefore, the UE stems from the allocated resource of the resource allocation scheme when it shall send the first measurement frame. The time transmission may be relating to the beginning of a system frame, a slot, or a symbol that the UE gets thanks to for instance the synchronisation signal of the FIG. 4.

In order to ensure the synchronisation accuracy between the gNB and the UE, the present method may be performed upon the sending of a reference time T_{R} by the gNB to the UE in view of the updating of the time counter of the UE.

FIG. 17 illustrates a second embodiment of the method according to the second aspect of the invention wherein the resource allocation scheme is first determined by the gNB, at step 1702, after obtaining synchronisation requirements (step 1701). At step 1703, the gNB then schedules the reference system frame (i.e. choses a reference time point and an associated reference time T_{R}) close to the resources (e.g. slots) having uplink and downlink resources offering the possibility to send the measurement frames. Therefore, the gNB schedules the transmission of the reference frame (hence the reference time point) such that the selected resource allocation scheme around the reference time point matches resource requirements for exchanging measurement frames.

FIG. 18 illustrates a third embodiment, similar to the one of FIG. 16, wherein, once the gNB selects a resource allocation scheme, the gNB sends a trigger frame to the UE to trigger the sending of the first (uplink) measurement frame, e.g. according to either the PTP-based approach or the TA-based approach.

Steps 1801 to 1804 are identical to the previously described steps 1601 to 1604.

Further to these steps, the gNB requests the UE to send an uplink measurement frame (i.e. the first measurement frame). Thus, as an alternative, the gNB may trigger the scheduling of the sending of the first measurement frame relatively to the reference time point of the reference system frame provided to the UE. This applies for both the PTP-based approach and the TA-based approach.

Upon the receiving of the gNB request, the UE may then schedule the sending of the first measurement frame for determining the propagation delay.

According to some embodiment, the gNB trigger frame may be for example the RTTmeasurement trigger frame as described in relation to FIG. 11.

According to some embodiments, in response to the gNB trigger frame, the UE may send the first measurement frame.

The gNB trigger frame should indicate the link between the requested measurement frame (for propagation delay measurement) and the reference time T_{R} (for synchronisation process). In other words, the gNB trigger frame should underline the propagation delay measurement is requested within the context of the synchronisation process of the time counters of the gNB and the UE.

According to some embodiments, the request is sent using a new flag included in the IE ReferenceTimeInfo when transmitted to the UE. Upon on the reception of the ReferenceTimeInfo with this new flag set to true, the UE is compelled to send a first measurement frame in response.

The embodiments of the method according to the second aspect of the invention are thus performed in parallel to the method according to the first aspect of the invention. In particular, based on the selected resource allocation scheme provided by the gNB, the UE (and optionally the gNB) may schedule the transmission of the first measurement frame of either PTP method or TA mechanism (and optionally the second measurement frame, in case of PTP method) to fall in resources having the appropriate uplink (and optionally downlink) property.

The resource allocation may be for time division duplex or frequency division duplex as illustrated hereinafter respectively in FIGS. 13 and 14. If a reference signal is used for computing the propagation delay as illustrated in FIG. 16, the resource allocation for the reference signals are also configured.

As an example, the UE may schedule the first measurement frame by choosing uplink symbols around the reference time point. This is possible because the gNB has provided slots or resources with the appropriate resource allocation scheme.

According to some embodiments, the gNB may schedule the second measurement frame by choosing downlink symbols around the reference time point.

Therefore, as illustrated by these three embodiments, in order to ensure that an accurate estimation of the propagation delay of the reference frame system is taking into consideration, the second aspect of the invention proposes a method of updating a time counter of a user equipment in a wireless network comprising at least one base station and a plurality of user equipment. The method comprises at the base station:
transmitting a reference frame to signal a reference time point associated with a reference time in a reference system frame, in order to set the time counter of the user equipment;
wherein the method further comprises:
selecting at least one resource within a system frame relatively to the reference time point of the reference system frame;
selecting at least one resource allocation scheme for the selected resource, a resource allocation scheme defining an allocation of each symbols of the selected resource to downlink transmission or uplink transmission or both;
performing a propagation delay measurement by exchanging at least one measurement frame using the selected resource.

Such a method ensures that the determination of a propagation delay between the UE and the gNB is performed as close as possible to the reference time point, in order to improve the accuracy of the updating of the time counter of the UE.

Exemplary scenarios with slot allocation schemes according to embodiments of the invention are illustrated in FIGS. 13, 14, and 15.

FIGS. 13, 14 illustrate uplink and downlink resource allocation scheme according to a first and second embodiments of the invention respectively in time division duplex mode and in frequency division duplex mode.

On the following figures, for ease of illustration, two subframes (#9 and #0) each comprises four slots (considered as resources) wherein uplink symbols are represented in black, downlink symbols are represented in grey and flexible symbols (that may be used either downlink or uplink) are represented in white.

In the present examples, the reference time point is defined at the end boundary of reference system frame #3. The propagation delay measurement preferably occurs close to this reference time point. That is why subframes #9 and #0 are the two subframes around the reference time point and are used for the exchange of the measurement frames.

In that way, the gNB selects slots close to the reference time point.

As shown in FIG. 13, the closest slots to the reference time point are in particular the last slot 1301 of the last subframe #9 of the reference system frame #3 and the first slot 1302 of the subsequent subframe #0 of following system reference #4. In the two illustrated examples of FIG. 13, the gNB selects the slots 1301 and 1302 as resources, and thus selects their slot allocation schemes to ensure the transmission of the frames required for determining the propagation delay.

Thus, two slots are selected both immediately adjacent to the reference time point, the ones respectively comprised in the reference system frame #3 and a system frame #4 immediately following the reference system frame.

According to some embodiments, the selected slots may be comprised in the same system frame. For instance, the selected slots may be comprised in the reference system frame or in a system frame adjacent to the reference system frame.

In the first example (middle of the figure), the two measurement frames (uplink and downlink) are sent before the reference time point, as illustrated in FIG. 12, in the same slot 1301. To do that, in this example, the chosen slot allocation scheme of the last slot 1301 of subframe #9 may be the predefined slot allocation scheme 55 that alternates uplink and downlink symbols. Of course, other scheme exists that also provide uplink and downlink symbols.

Thus, the measurement frames 1303 and 1304 are respectively sent using some of the uplink symbols (here symbols 5, 6 and 7) and some of the downlink symbols (8, 9 and 10).

Still in this first example, the follow-up message is sent shortly after the reference time point, in the first slot 1302. To do that, in this example, the chosen slot allocation scheme of the first slot 1302 of the first subframe #0 of the system frame #4 following the reference system frame #3 may be the predefined slot allocation scheme 1 containing only downlink symbols. Of course, other scheme exists that also provide downlink symbols.

Thus, the follow-up message 1306 comprising t2 and/or t3 or gNB_{Tx-Rx} is transmitted to the UE using some of these downlink symbols, e.g. symbols 5, 6 and 7.

Thus, by choosing the slot allocation scheme of the slots 1301 and 1302 adjacent to the reference time point in view of the propagation delay measurement, the gNB enables the propagation delay measurement to be performed close to the reference time point.

In a second example (bottom of the figure), the first measurement frame 1303 (uplink) is sent before the reference time point, and both the second measurement frame 1304 (downlink) and the follow-up message 1306 (downlink), if any, are sent after the reference time point, as illustrated in FIG. 7.

To do that, in this example, the chosen slot allocation scheme of the last slot 1301 of subframe #9 may be the predefined slot allocation scheme 0, containing only uplink symbols. Of course, other scheme exists that also provide uplink symbols.

Thus, the first measurement frame 1303 is sent by the UE using some of the uplink symbols of the slot 1301, e.g. 0-3.

Still in the second example, the second measurement frame 1304 and the follow-up message, if any, are sent shortly after the reference time point, during the slot 1302. To do that, in this example, the chosen slot allocation scheme of the first slot 1302 of the first subframe #0 of the system frame #4 following the reference system frame #3 may be the predefined slot allocation scheme 1 containing only downlink symbols. Of course, other scheme exists that also provide downlink symbols.

Thus, the second measurement frame 1304 and the follow-up message 1306 comprising t2 and/or t3 or gNB_{Tx-Rx} are transmitted to the UE using some of these downlink symbols, e.g. respectively symbols 0-4, and symbols 11-13.

In both examples, according to the size of the messages (measurement frames and follow-up messages) and the subcarrier spacing used, the number of the symbols used for the transmission may vary.

In FIG. 14, similarly to FIG. 13, the gNB selects the closest slots to the reference time point in order to select an appropriate resource allocation scheme to enable the determination of the propagation accordingly to the first aspect of the invention. The closest resources are in particular the last slot 1401 of the last subframe #9 of the reference system frame #3 and the first slot 1402 of the subsequent subframe #0 of following system frame #4.

The proposed resource allocation of FIG. 14 is in frequency division duplex such that it relies on two frequencies F1 and F2 (more frequencies may be contemplated) as illustrated. In other words, during slots 1401 and 1402, messages may be sent using symbols organized over two (or more) different frequencies (of two different subcarriers). OFDM symbols can be used as mentioned above.

Therefore, unlike FIG. 13, slots 1401 and 1402 comprises two frequencies.

The resource allocation scheme of slot 1401 is chosen by the gNB such that it comprises:
on a first frequency, only uplink symbols. Of course, another scheme that provides sufficient uplink symbols may be used,
on a second frequency, only downlink symbols. Of course, another scheme that provides sufficient downlink symbols may be used.

In the example shown, the resource allocation scheme of slot 1402 is chosen by the gNB such that it comprises only downlink symbols on both first and second frequency. Of course, other schemes that provide sufficient downlink symbols may be used.

Thereby, the first measurement frame 1403 is transmitted by the UE using some of the uplink symbols on the first frequency of slot 1401. The second measurement frame 1404 and the follow-up message 1406 are respectively transmitted by the gNB using some of the downlink symbols on the second frequency of slot 1401 (for the first measurement frame) and some of the downlink symbols on the second frequency of slot 1402 (for the follow-up message).

Thus, the first and second measurement frames 1403, 1404 are sent in parallel close to the reference time point.

Of course, this example is not restrictive, such that the downlink frames, i.e. the second measurement frame and the follow-up message, may be sent using any of the downlink symbols of slot 1401 on the second frequency and of slot 1402 on both frequencies.

Further, the allocation may be inverted such that the first slot 1401 only comprises downlinks symbols on both frequencies, and the second slot 1402 comprises only downlink symbols on a second frequency and only uplink symbols on a first frequency.

Then, the gNB declares to the UE the chosen resource allocation scheme so that the UE knows which symbols/frequency carriers it may use to transmit or receive data to or from the gNB. The sequencing of the resource allocation, i.e. the configuration of the uplink and downlink slots, is provided by the gNB to the UE through several ways as described above.

The examples of FIGS. 13, 14 and 15 (if only SRS is used) also apply to the TA-based approach wherein no second measurement frame is sent.

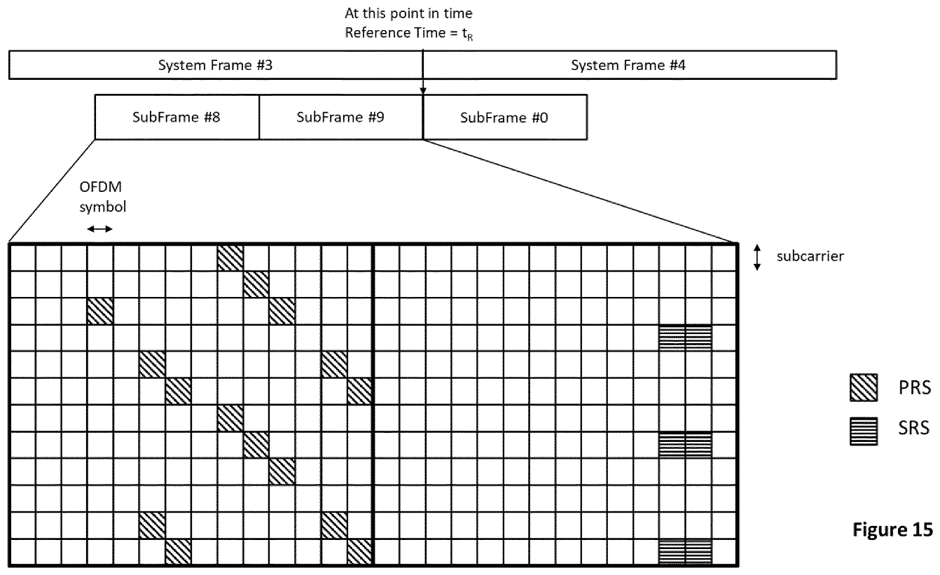

FIG. 15 illustrates a third embodiment of a resource allocation, wherein reference signals Position Reference Signal (PRS) and Sounding Reference Signal (SRS), typically used in positioning framework as defined in TS 38.215 section 5.1.30, are used as measurement frames according to the first aspect of the invention.

PRS and SRS signals are dedicated signals to compute the time differences UE_{Rx-Tx} and gNB_{Tx-Rx} that are used, as explained in relation to FIGS. 7a and 7b, to determine the propagation delay.

To ensure that the PRS and SRS signals are sent in the closeness of the reference time point, in this example, the two last subframes of the references system frame #3, namely subframe #8 and subframes #9, comprises symbols reserved by the gNB respectively for the downlink transmission of PRS and uplink transmission of SRS.

Subframe #8 is selected and its resource allocation scheme provides only downlink symbols made of a plurality of subcarriers. The PRS, considered as the second measurement frame, is transmitted to the UE by the gNB, over slots (and symbols) of the selected subframe #8.

Similarly, subframe #9 is selected and its resource allocation scheme provides only uplink symbols made of a plurality of subcarriers. The SRS, considered as the first measurement frame, is received from the UE over the slots of this subframe #9.

In this example, subframes #8 and #9 are the last subframes of the same system frame, preferably the reference system frame. It may be possible that the selected subframes may be comprised in two consecutives system frames.

The first and second patterns, i.e. the configuration of the sending of SRS and PRS, may vary. The gNB shall ensure that the pattern remains compatible with the format of the symbols used for their sending, i.e. the resource allocation scheme.

With this configuration, the first and second measurement frames are sent close to the reference time point.

The configuration of the reference signals PRS and SRS are defined in the standard TS38.211 respectively at section 7.4.1.7 and 6.4.1.4.

The configuration of PRS and SRS enables the gNB to specify the resources allocated for the transmission of these reference signals. The configuration also allows to specify the periodicity characterizing the sending pattern.

SRS and PRS configuration may also allow an aperiodic configuration that may be triggered by DCI comprising respectively a SRS request and/or a PRS request. For example, only one SRS message may be sent.

The gNB trigger frame of the third embodiment of FIG. 18, is compatible with the resource scheme allocations described hereinbefore. In the embodiments of FIGS. 13 and 14, the gNB trigger frame may be sent in PDCCH of the system frame including the transmission of IE ReferenceTimeInfo comprising information relating to both reference time and reference time point. In the embodiment of FIG. 15, the gNB trigger frame may be sent in the PDCCH of the reference system frame by using SRS request field in the DCI.

It is also provided a computer program product for a programmable apparatus which comprises a sequence of instructions for implementing the previously described embodiments of the first and second aspect of the invention when loaded into and executed by the programmable apparatus.

Besides, it is also provided a non-transitory computer-readable storage medium storing instructions of a computer program for implementing the previously described embodiments of the first and second aspect of the invention.

Any step of the algorithms of the first and second aspect of the invention may be implemented in software by execution of a set of instructions or program by a programmable computing machine, such as a PC (“Personal Computer”), a DSP (“Digital Signal Processor”) or a microcontroller; or else implemented in hardware by a machine or a dedicated component, such as an FPGA (“Field-Programmable Gate Array”) or an ASIC (“Application-Specific Integrated Circuit”).

Although the first and second aspect of the invention has been described hereinabove with reference to specific embodiments, the of the first and second aspect of the invention is not limited to the specific embodiments, and modifications will be apparent to a skilled person in the art which lie within the scope of the first and second aspect of the present invention.

Many further modifications and variations will suggest themselves to those versed in the art upon making reference to the foregoing illustrative embodiments, which are given by way of example only and which are not intended to limit the scope of the first and second aspect of the invention, that being determined solely by the appended claims. In particular, the different features from different embodiments may be interchanged, where appropriate.

Each of the embodiments of the first and second aspect of the invention described above can be implemented solely or as a combination of a plurality of the embodiments. Also, features from different embodiments can be combined where necessary or where the combination of elements or features from individual embodiments in a single embodiment is beneficial.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of updating a time counter of a user equipment in a wireless network comprising a base station and a plurality of user equipment, the method comprising, at the user equipment:
receiving a reference time and an indication for determining a reference time point associated with the reference time;
scheduling a determining of a propagation delay relatively to the reference time point;
determining a propagation delay with the base station according to the scheduling; and
updating the time counter using the reference time and the determined propagation delay.

2. The method of claim 1, wherein scheduling the determining of the propagation delay further comprises:
scheduling the transmission of a first measurement frame relatively to the reference time point.

3. The method of claim 2, wherein the first measurement frame is scheduled to be transmitted during a reference system frame comprising the reference time point, preferably during a reference system subframe comprising the reference time point or a reference system subframe preceding the reference subframe comprising the reference time point.

4. The method of claim 2, wherein the first measurement frame is scheduled to be transmitted during a predetermined system frame preceding a reference system frame comprising the reference time point, preferably immediately preceding the reference system frame.

5. The method of claim 1, wherein scheduling the determining of the propagation delay further comprises:
determining a time to initiate the determining of the propagation delay, based on a system frame number of a current system frame, a current value of the time counter and a system frame number of a reference system frame comprising the reference time point.

6. The method of claim 5, wherein scheduling the determining of the propagation delay further comprises:
setting a decrementing timer to the determined initiation time; and
initiating the determining of the propagation delay when the decrementing timer expires.

7. The method of claim 1, wherein scheduling the determining of a propagation delay includes retrieving, from a message received from the base station, a transmission time setting the time for transmission of a first measurement frame,
and wherein the determining of the propagation delay includes receiving, from the base station, a Timing Advance command comprising information relating to a propagation delay estimated by the base station.

8. The method of claim 1, wherein the determining of a propagation delay with the base station comprises:
transmitting a first measurement frame to the base station;
storing a time of transmission of the first measurement frame;
receiving a second measurement frame from the base station; and
storing a time of receiving of the second measurement frame.

9. (canceled)

10. (canceled)

11. The method of claim 1, further comprising, at the user equipment:
receiving, from the base station, at least one parameter for determining the propagation delay with the base station.

12. (canceled)

13. (canceled)

14. (canceled)

15. (canceled)

16. (canceled)

17. A method of updating a time counter of a user equipment in a wireless network comprising a base station and a plurality of user equipment, the method comprising, at the base station:
transmitting an indication for determining a reference time point in a reference system frame; and
transmitting a measurement frame to the user equipment for determining by the user equipment of a propagation delay with the base station and updating the time counter of the user equipment;
wherein the transmission of the measurement frame is scheduled relatively to the reference time point of the reference system frame.

18. A method of updating a time counter of a user equipment in a wireless network comprising at least one base station and a plurality of user equipment, the method comprising at the base station:
transmitting an indication for determining a reference time point in a reference system frame;
wherein the method further comprises:
selecting at least one resource within a system frame;
selecting at least one resource allocation scheme for a selected resource of the at least one selected resource, a resource allocation scheme defining an allocation of symbols of the selected resource to downlink transmission or uplink transmission or both;
performing a propagation delay measurement by exchanging at least one measurement frame using the selected resource.

19. The method of claim 18, wherein the selected resource is a time slot of a system frame and the selecting steps further comprises:
selecting at least one time slot in a system frame relatively to the reference time point of the reference system frame;
selecting, for each selected time slot, a slot allocation scheme from amongst predefined slot allocation schemes, a slot allocation scheme defining an allocation of each symbol composing a time slot to downlink transmission or uplink transmission or both.

20. The method of claim 18, wherein a selected resource is comprised in the reference system frame or in a system frame adjacent to the reference system frame.

21. The method of claim 18, wherein a selected resource is immediately adjacent to the reference time point.

22. The method of claim 18, wherein a selected resource allocation scheme for a first selected resource includes at least one uplink symbol and a first measurement frame is received from the user equipment over the at least one uplink symbol.

23. The method of claim 22, wherein the selected resource allocation scheme for the first selected resource further includes at least one downlink symbol and a second measurement frame is transmitted to the user equipment over the at least one downlink symbol.

24. (canceled)

25. (canceled)

26. The method of claim 22, wherein a selected resource allocation scheme for a second selected resource includes at least one downlink symbol and at least one further measurement frame is transmitted to the user equipment over the at least one downlink symbol.

27. The method of claim 26, wherein the at least one further measurement frame includes a second measurement frame.

28. The method of claim 26, wherein the at least one further measurement frame includes a follow-up measurement frame providing the user equipment with time information of one or more exchanged measurement frames.

29. (canceled)

30. (canceled)

31. The method of claim 18, wherein all slots of a subframe in a system frame are selected with a resource allocation scheme providing only uplink symbols made of a plurality of subcarriers, and a first measurement frame is received from the user equipment over slots of this subframe.

32. The method of claim 31, wherein all slots of another subframe in a system frame are selected with a resource allocation scheme providing only downlink symbols made of a plurality of subcarriers, and a second measurement frame is transmitted to the user equipment over slots of this other subframe.

33. (canceled)

34. (canceled)

35. (canceled)

36. A method of updating a time counter of a user equipment in a wireless network comprising a base station and a plurality of user equipment, the method comprising at the base station:
transmitting a reference frame to signal a reference time point associated with a reference time, in order to set the time counter of the user equipment;
performing a propagation delay measurement by exchanging at least one measurement frame using at least one resource of a system frame,
wherein the reference time point is determined based on a resource allocation scheme of the at least one resource.

37. A device in a wireless network comprising at least one base station and a plurality of user equipment comprising a processor configured to perform the steps of claim 1.

38. (canceled)

39. (canceled)

40. The method of claim 11, wherein a measurement frame of the at least one measurement frame is a Position Reference Signal (PRS) or a Sounding Reference Signal (SRS).
